(19) United States
(12) Patent Application Publication
(10) Pub. No.: US 2023/0206274 A1
(43) Pub. Date: Jun. 29, 2023

(54) SYSTEMS, METHODS AND COMPUTER PROGRAM PRODUCTS FOR VALIDATING PAYMENT OF IN-STORE PURCHASE OFFERS PROVIDED TO MOBILE DEVICES

(71) Applicant: H & M HENNES & MAURITZ AB, STOCKHOLM (SE)

(72) Inventor: Patrik LINDERED, STALLARHOLMEN (SE)

(21) Appl. No.: 17/928,602

(22) PCT Filed: May 28, 2021
(86) PCT No.: PCT/EP2021/064384

§ 371 Date: Nov. 29, 2022

(30) Foreign Application Priority Data
May 29, 2020 (SE) 2050618-4

(51) Int. Cl. G06Q 30/0238; G06Q 20/32; G06Q 20/40

(52) U.S. Cl. CPC G06Q 30/0238; G06Q 20/3274; G06Q 20/401

(57) ABSTRACT

The present invention relates to a system, methods and computer program products for verifying a completed payment transaction and provide purchase offers. A control system is configured to receive, from a mobile device, event data indicating that the consumer has completed a payment transaction including the purchase of at least one product of a purchase offer available at a first store and then subsequently provide a subsequent second purchase offer. The subsequent purchase offer may be created at least partly based on previously obtained event data. An optically readable code may then be used for verifying the second purchase offer in a second store different from the first store.

### TECHNICAL FIELD

The present invention is generally directed to a system, methods and computer program products for dynamically providing discount and subsequent purchase offers in response to a completed payment transaction and. In various embodiments, the discounts or subsequent purchase offers are made available to the customer in the form of optically readable codes displayed on the customer's mobile device. The optically readable code may then be used for validating or verifying the discount and/or second purchase offer in a second store different from the first store, and/or may be used for opening an exit gate and/or deactivating an alarm tag attached to the physical product items at the self-checkout desk in the first store and/or at the exit gate of the first store.

### BACKGROUND

Advances in mobile technology have enhanced in-store shopping activities by allowing consumers to purchase items in real-time. For example, consumers now have access to the application programs (APPs) on mobile devices such as cell phones, smart phones and personal data assistants that facilitate the identification and purchase of items without physical presentation of the item to a point-of-sale terminal. So-called “scan and buy” APPs eliminate the frustrating experience of waiting in a check-out line and can increase sales by eliminating when consumers remove items from their shopping cart prior to checkout.

Mobile devices such as mobile phones permit retailers to connect with their customers and barcodes, such as QR codes, supply the interactive means to accomplish this. These barcodes can easily direct a retail establishment's customers to their Twitter, Facebook, and other social networking accounts. For example, a QR code could take customers to a mobile e-commerce site or a product demo. Barcodes such as QR codes may be indispensable when a retailer has online campaigns, advertisements, or TV commercials. QR codes can also be used to encourage customers to purchase products by relaying valuable information and alerting them to upcoming sales, unique promotions, and offering them an interactive view of new products on the way.

Retailers can also utilize QR codes to capture important customer information. For example, retailers can include a simple sign-up feature on the QR destination page to encourage visitors to enter their email address for special deals.

Customer Relationship Management (CRM) systems, client databases and methods use various information technologies to learn a customer's preferences, offer products and special deals to the customer according to those preferences, and to foster or reward customer loyalty. In order to maintain a high level of customer loyalty, it is desirable for a retailer to enhance a customer's in-store experience by anticipating her preferences and offering customized services.

Merchants, especially those that derive their revenue from online sales, are keenly interested in spending significant marketing dollars analyzing data generated by these events to increase their conversion rates. Once in a physical store, however, such analysis techniques typically disappear. Consumers can pick up, view, analyze and even open a product, place it in their basket for a while, and the merchant has no information about the event. Such events may provide even more insights into the shopping habits and product preferences of a consumer than online activities.

### Problems with the Prior Art

Consumers are beginning to rely on web-based solutions as an alternative to traditional in-store shopping. As a result, electronic commerce has expanded the focus of large retailers by offering on-line purchasing as a method for providing a broader assortment of products and pricing options to consumers. Typically, this occurs outside of the retail establishment which in turn eliminates in-store merchandising and promotion opportunities.

Retailers are constantly exploring ways to communicate with their shoppers utilizing mobile technologies. Many applications focus on promotion messaging that encourages consumers to shop in their stores. Many mobile applications for shoppers are offered by third party service providers. While the service may vary, they are typically offer based and utilize location services with the aid of zip codes and global positioning systems (GPS). These applications target interest such as store locators, weekly circulars, digital coupons or offers, generic item pricing, and the like.

Current technology offers consumer search options and the ability to find items, locate where they are offered and at what price. However, these pricing applications offer retailers little benefit unless they are a low-price leader in the market Therefore, there is a need for systems and methods adapted to enhance the costumer's shopping experience by providing product information and purchase offers in real-time to the consumer while in-store and where the offers are adapted to be personalized and relevant for the customer in being based on the consumer's shown interest in a product and previous shopping behavior, and such that the consumer may easily purchase products in-store.

Moreover, customers are individuals who usually have personal preferences for purchasing different products. The individuals often visit known similar stores to purchase their preferred products. Merchants desire to capture an insight into a future propensity of an event in relation to the individual and construct purchase offers accordingly. Based on this insight, the merchants can drive personalized recommendations and provide purchase offers to individuals in real-time while the customer is in the store to thereby improve their sales revenue. Conventionally, these personalized recommendations and offers may not be relevant, as the recommendations may characterize offers from merchants located in places distant from the individual. Thus, the relevance of these personalized recommendations and offers can be further improved by using knowledge about the historical shopping behaviour of the individual as well as knowledge about previously recorded purchases by other customers of products the individual shows an interest or previously recorded purchases of products associated with the product the individual shows an interest.

### SUMMARY

What is needed is a system and methods for providing a customer with in-store purchase offers reflecting the customer's shown interest and shopping behaviour and presented to the customer while the customer is present in a store where the at least one product of the purchase offer are available.

What is further needed is a system and methods for validly and securely verifying, in real-time and to a staff member at the store and/or the cashier system or computer system of the store, that a customer, or user of a mobile device, can take advantage of a purchase offer, e.g. a customized or personalized purchase offer, provided to the customer while in the store.

The system, methods and computer program products of the technology disclosed is adapted to provide a customer with an optically readable verification code, displayed on the customer's mobile device, in response to event data indicating the event of the customer's completed payment transaction for purchasing the products of a purchase offer provided to the customer while the customer is present in a store in which products of the purchase offer are available as physical product items.

In embodiments, the technology disclosed relates to a system, methods and computer program products for capturing and acting in response to a sequence of events or subsequently received event data, e.g. automatically and in real-time, in order to display an optically readable code on the screen/display of the customer's mobile device.

In embodiments, the technology disclosed relates to a system, methods and computer program products for providing a user of a mobile device with an optically readable code following a successfully payment transaction including the purchase of the at least one product of a purchase offer which was previously provided to the customers present in a store. The optically readable code may then be displayed on the display of the mobile device following the identifying of at least one event indicating a successfully completed payment transaction for purchasing the at least one product of the purchase offer.

In embodiments, the technology disclosed relates to a system, methods and computer program products for providing a user of a mobile device with an optically readable code following a successfully payment transaction including the purchase of the at least one product of a purchase offer which was previously provided to the customers present in a store, where the optically readable code is displayed on the display of the mobile device in response to the step of identifying at least one event indicating the successfully completed payment transaction.

In embodiments, the technology disclosed relates to a system, methods and computer program products for providing a user of a mobile device with an optically readable code following a successfully payment transaction including the purchase of the at least one product of a purchase offer which was previously provided to the customers present in a store, where the optically readable code is displayed on the display of the mobile device in response to obtained or received event data indicating the successfully completed payment transaction.

In embodiments, the payment transaction is conducted with the mobile device and the at least one event indicating the successfully completed payment transaction is identified by the mobile device. In certain embodiments, event data is transmitted from the mobile device to a backend system, or control system, following the identifying of the successfully completed payment transaction and the mobile device receives, in response, an optically readable code, or data adapted for generating or displaying an optically readable code from the backend system.

In embodiments, the payment transaction is conducted without any direct involvement by the mobile device and the at least one event indicating the successfully completed payment transaction is identified by an application program, a store APP, running on a separate communication device from the mobile device. The event data may then be transmitted from the separate communication device to a backend system, or control system, following the identifying of the successfully completed payment transaction and the mobile device may, in response to the backend system receiving the event data from the separate communication device, receive, from the backend system, an optically readable code or data adapted for generating and/or displaying an optically readable code on the mobile device. The separate communication device may then be a computer, tablet or mobile communication device which is operated by a staff member and the payment transaction may then be conducted by use of the separate communication device and/or the cashier system of the store.

In embodiments, the technology disclosed relates to a system, methods and computer program products for capturing and acting in response to a sequence of events or subsequently received event data including event data representing a successfully completed payment transaction for purchasing the at least one product of a purchase offer, e.g. automatically and in real-time, in order to display an optically readable code, on the screen/display of the customer's mobile device, where the optically readable code is adapted to validate or verify that the customer is authorized to take advantage of a discount and/or second purchase, and/or is adapted for opening an exit gate or deactivating an alarm tag attached to a physical product item of a product of a purchase offer provided to the customer's mobile device while in the store. In certain embodiments, the event data transmitted in response to an identified successfully completed payment transaction for purchasing the at least one product of a purchase offer may be transmitted to the control system by a separate communication device from the mobile device receiving the optically readable code from the control system. In certain embodiments, the purchase offer was provided by the control system to the predetermined group of mobile devices including the mobile device and in response to the scanning of a barcode label associated with the physical product item

In embodiments, the technology disclosed relates to a system, methods and computer program products for capturing and acting in response to a sequence of events or subsequently received event data, e.g. automatically and in real-time, in order to display an optically readable code for validating or verifying on the screen of the customer's mobile device that the customer is authorized to take advantage of a second purchase offer in response to event data indicating a successfully completed payment transaction including the purchase of the product items of a first purchase offer provided to the customer while in the store. In certain embodiments, the event data transmitted in response to an identified successfully completed payment transaction for purchasing the at least one product of a purchase offer may be transmitted to the control system by a separate communication device from the mobile device receiving the optically readable code from the control system.

In embodiments, the first purchase offer is including at least the purchase of a product item of the first product or first product category.

In embodiments, the first purchase offer is including at least the purchase of a product item of a second product or second product category different from the first product or first product category.

In aspects, the user of a mobile device who shows up at the cahier's desk with physical product items corresponding to the at least one product item of a first purchase offer provided to the user's mobile device is subsequently, and in response to further event data received from the same mobile device indicating a successfully completed payment transaction including the purchase of the product items of a first purchase offer, provided with an optically readable code adapted for securely validating or verifying to a staff member and/or a cashier system or a computer system of another store, or stores of another chain, than the store in which the first purchase offer was provided to the customer's mobile device, that the user of the mobile device is authorized to take advantage of a discount and/or second purchase offer, e.g. a customized or personalized second purchase offer. The discount and/or second purchase offer may then be only valid for purchasing at least one additional product available at the other store, or store chain, and the physical product items of the at least one additional product may only be available for sale at the other store, or stores of the other store chain, and not at the store in which the customer completed the payment transaction for purchasing the at least one product item of the first purchase offer. In embodiments, the optically readable code is provided to a predetermined group of mobile devices associated with, e.g. in a database of the control system, the mobile device performing the scanning of a barcode label associated with a physical product item in the store, where the receiving of the barcode by the control system triggered the control system to provide the mobile device with the first purchase offer. In certain embodiments, the first purchase offer was provided by the control system to the same predetermined group of mobile devices in response to the scanning of a barcode label associated with the physical product item.

In aspects, the technology disclosed relates to a method of receiving, by a control system or backend system, event data from a mobile device and, in response to receiving the event data transmitted in response to identifying a successfully completed payment transaction including the purchase of products of a first purchase offer, transmitting, from the control system, an optically readable code or data adapted for displaying an optically readable code to be presented on the display of the mobile device, where the optically readable code, when scanned, read or recognized, is adapted to validate or verify that the user of the mobile device is authorized to take advantage of a discount or a second purchase offer. The first purchase offer may then have been provided to the mobile device through the transmission of data representing the purchase offer from the control system and in response to the acquiring or scanning of an image or barcode associated with a physical product item in the store where the verification by the acquiring or scanning is performed. The event data transmitted from the mobile device to the control system may then have been transmitted by the mobile device in response to identifying, by the mobile device, at least one event indicating the successfully completed payment transaction including the purchase of products of the first purchase offer provided to the mobile device.

In aspects, the technology disclosed relates to a control system, or backend system, configured to receive event data from a mobile device and, in response to receiving the event data transmitted in response to identifying a successfully completed payment transaction including the purchase of products of a first purchase offer, transmit an optically readable code or data adapted for displaying an optically readable code to be presented on the display of the mobile device, where the optically readable code, when scanned, read or recognized, is adapted to validate or verify that the user of the mobile device is authorized to take advantage of a discount or second purchase offer in another store, or store chain, different from the store, or store chain, in which the customer completed the payment transaction for purchasing the at least one product item of the first purchase offer. The first purchase offer may then have been provided to the mobile device through the transmission of data representing the purchase offer from the control system and in response to the acquiring or scanning of an image or barcode associated with a physical product item in the store where the acquisition or scanning was conducted. The event data transmitted from the mobile device to the control system may then have been transmitted by the mobile device in response to identifying, by the mobile device, at least one event indicating a successfully payment transaction for purchasing the at least one product item of the first purchase offer. In embodiments, the optically readable code is provided to a predetermined group of mobile devices associated with, e.g. in a database of the control system, the mobile device performing the scanning of a barcode label associated with a physical product item in the store, where the receiving of the barcode by the control system triggered the control system to provide the mobile device with the first purchase offer. In certain embodiments, the first purchase offer was provided by the control system to the same predetermined group of mobile devices in response to the scanning of a barcode label associated with the physical product item.

In aspects, the technology disclosed relates to a method for providing a user of a mobile device with a verification code following a payment transaction including a purchase offer provided to the customers present in a store, said method comprising:
a. acquiring or scanning, by an image acquisition component or a scanner operatively connected to the mobile device, an image or barcode associated with a physical product item being offered for sale by the store, wherein said physical product item belongs to a first product or first product category;
b. transmitting, by said mobile device, said image or barcode, or data representing said image or barcode, to a control system which is comprising, or is at least one of operatively coupled to and communicatively connected, to a database;
c. transmitting, from the control system to the mobile device, data representing a first purchase offer identified by said control system in response to receiving said image or barcode, or in response to receiving said data representing said image or barcode;
d. displaying, in a browser or an application program running on the mobile device and on the screen of said mobile device, data representing said first purchase offer, wherein said displaying of data representing said first purchase offer is performed in response to said mobile device receiving said data representing said first purchase offer;
e. conducting a payment transaction including the purchase of product items of said first purchase offer;
f. identifying the event of a successfully completed payment transaction including the purchase of the product items of said first purchase offer; and
g. displaying, in the application program running on the mobile device, an optically readable code, wherein said optically readable code is displayed following the identifying of the event of a successfully completed payment transaction.

In embodiments, the first purchase offer is including at least the purchase of a product item of said first product or first product category.

In embodiments, the first purchase offer is including at least the purchase of a product item of a second product or second product category different from said first product or first product category.

In embodiments, the content of said optically readable code is representing a second purchase offer different from said first purchase offer, and said optically readable code is adapted to be used for validating or verifying, when scanned or read, that the user of the mobile device is authorized to take advantage of said second purchase offer.

In embodiments, the optically readable code is representing a second purchase offer different from said first purchase offer, and said optically readable code is adapted to be used for validating or verifying, to a staff member, a cashier system, and/or a computer system, unit and/or device in the store and when inspected by the staff member or scanned or read by a scanner or image acquisition or recognition device in the store, that a successfully completed payment transaction including the purchase of the product items of said first purchase offer has been validly completed.

In embodiments, said payment transaction is conducted by the use of said mobile device, and said event of a successfully completed payment transaction is identified by the application program running on said mobile device.

In certain embodiments, the optically readable code representing a second purchase offer for use in a separate second store was provided by the control system to a predetermined group of mobile devices including the mobile device in response to receiving the event data from the mobile device identifying the event of a successfully completed payment transaction including the purchase of the product items of the first purchase offer.

In certain embodiments, the first purchase offer was provided by the control system to a predetermined group of mobile devices including the mobile device in response to receiving the barcode or image following the scanning of a barcode, or acquiring of an image, associated with the physical product item in the store and which is adapted for identifying the first product to which the physical product item belongs.

In embodiments, the event data representing the event of identifying a successfully completed payment transaction is transmitted from a separate communication device to the control system, and the data for generating and/or displaying said optically readable code following the successfully completed payment transaction is transmitted from the control system to the mobile device in response to receiving the event data representing the identified event of a successfully completed payment transaction.

In embodiments, the optically readable code is provided to a predetermined group of mobile devices associated with the mobile device performing the scanning of a barcode label associated with a physical product item in the store, where the receiving of the barcode by the control system triggered the control system to provide the mobile device with the first purchase offer. In certain embodiments, the first purchase offer was provided by the control system to the same predetermined group of mobile devices in response to the scanning of a barcode label associated with the physical product item.

In embodiments, said event of a successfully completed payment transaction is identified by the control system based on event data received from the cashier system of the store or other computer system, unit or communication device of the store, and data for generating and/or displaying said optically readable code is transmitted from the control system to said mobile device in response to receiving said event data representing said identified event of a successfully completed payment transaction from the cashier system of the store or other computer system, unit or communication device of the store.

In embodiments, the method further comprises the steps of:
a. transmitting, from said mobile device to said control system, event data representing the identified event of said successfully completed payment transaction including the purchase of the product items of said first purchase offer; and
b. transmitting, from the control system to said mobile device, data adapted to be used for generating an optically readable code, wherein said transmission of said data is performed in response to and triggered by said control system receiving said event data representing the identified event of said successfully completed payment transaction including the purchase of the product items of said first purchase offer.

In embodiments, the method further comprises the steps of:
c. generating, by the application program running on said mobile device, an optically readable code corresponding to said data adapted to be used for generating an optically readable code; and
d. displaying, by the application program running on said mobile device and on the screen of said mobile device, said optically readable code.

In embodiments, the method further comprises the following steps prior to conducting the payment transaction:
a. identifying, by the application program running on the mobile device, the event of accepting, by the user of the mobile device, said first purchase offer; and
b. displaying, by the application program running on said mobile device, an optically readable code representing said first purchase offer or reflecting the items currently in the shopping basket including the product items of said first purchase offer, wherein said optically readable code representing said first purchase offer is a different optically readable code from the optically readable code displayed following said successfully completed payment transaction including the purchase of the product items of said first purchase offer.

In embodiments, said optically readable code representing said first purchase offer or reflecting the items of the shopping basket, when scanned or read by a scanner or image acquisition device in the store, is adapted to validate or verify to staff members in the store or to the cashier system of the store that the user of the mobile device is authorized to take advantage of said first purchase offer.

In embodiments, the method further comprises the steps of:
a. generating, by the application program running on said mobile device, said optically readable code representing a second purchase offer different from said first purchase offer, wherein said optically readable code is generated in response to said identifying of the event of a successfully completed payment transaction; and
b. displaying, by the application program running on said mobile device and on the screen of said mobile device, said optically readable code representing said second purchase offer, wherein said optically readable code, when scanned or read by a scanner or image acquisition or recognition device in a second store different from said store, is adapted to validate or verify that the user of the mobile device is authorized to take advantage of said second purchase offer and may proceed to payment in accordance with the price and conditions of said second purchase offer.

In embodiments, said optically readable code, when scanned by a scanner in a second store or shown to staff members in the second store, is adapted to be used for validating or verifying, at the second store, that the user of the mobile device is authorized to take advantage of a second purchase offer including at least one product available for sale at the second store.

In embodiments, the at least one product of the second purchase offer available for sale at the second store is not available for sale at the store where the barcode associated with a physical product item was scanned.

In embodiments, the cashier system of the second store is a different cashier system than the cashier system of the store where the barcode associated with a physical product item was scanned.

In embodiments, the second store does not belong to the same store chain as the store in which the barcode associated with a physical product item was scanned.

In embodiments, said optically readable code displayed following the identifying of the event of a successfully completed payment transaction, when scanned or read by a scanner or image acquisition or recognition device at a self-checkout desk in the store, is adapted to be used for deactivating an alarm tag attached to the product items of said first purchase offer.

In embodiments, said optically readable code displayed following the identifying of the event of a successfully completed payment transaction, when scanned or read by a scanner or image acquisition or recognition device at a self-checkout desk in the store, is (automatically) deactivating an alarm tag attached to the product items of said first purchase offer, where said deactivation is automatically performed in response to said scanning or reading of said optically readable code. In certain embodiments, the successfully completed payment transaction may then be conducted by use of a digital wallet based mobile phone or smartphone.

In embodiments, said optically readable code, when scanned or read by a scanner or image acquisition or recognition device at a self-checkout desk in the store and/or at the exit gate of the store, is adapted to be used as a gate opener for opening an exit gate.

In embodiments, said optically readable code, when scanned or read by a scanner or image acquisition or recognition device at a self-checkout desk in the store and/or at the exit gate of the store, is automatically opening the exit gate in response to said scanning or reading of the optically readable code.

In embodiments, the method further comprises the step of:
c. acquiring, by an image acquisition device operatively coupled to or communicatively connected to the cashier system of the store, said optically readable code representing said first purchase offer, thereby validating or verifying that the user of the mobile device is authorized to take advantage of said second purchase offer and may proceed to payment.

In embodiments, the method further comprises the step of:
d. scanning, by a scanner operatively coupled to the cashier system of the store, said optically readable code representing said first purchase offer, thereby validating or verifying that the user of the mobile device is authorized to take advantage of said second purchase offer and may proceed to payment.

In embodiments, the method further comprises the step of:
e. conducting said payment transaction by purchasing at least one item of said second product or second product category and/or in accordance with the price and/or conditions of said first purchase offer, wherein said payment transaction is conducted following said scanning of said optically readable code representing said first purchase offer is validating or verifying that the user of the mobile device is authorized to take advantage of said first purchase offer.

In embodiments, said the optically readable code also includes payment credentials of the customer associated with the mobile device and said payment transaction is conducted automatically in response to scanning or acquiring an image of said optically readable code representing said first purchase offer by a scanner or an image acquisition device operatively coupled to or communicatively connected to the cashier system of the store.

In embodiments, the method further comprises the following steps prior to transmitting said data representing said first purchase offer:
a. transmitting, from said control system to said mobile device, product and/or price information for said first product or first product category, wherein said product and/or price information for said first product is transmitted in response to receiving said barcode or data representing said barcode;
b. displaying, on the display of said mobile device, said product and/or price information for said first product or first product category;
c. identifying, by the application program running on the mobile device, an event associated with said first product or first product category, wherein said event comprises identifying at least one of the actions of adding at least one item of the first product or first product category to the shopping basket of the application program and checking out at least one item of the first product or first product category for payment; and
d. transmitting, from the mobile device and in response to identifying said event associated with said first product or first product category, event data representing said event associated with said first product or first product category, wherein said step of transmitting data representing said first purchase offer is performed in response to said control system receiving said event associated with said first product or first product category.

In embodiments, said step of identifying said event of accepting said purchase offer comprises identifying, by the application program, at least one of the events of:
f. adding, to the shopping basket of the application program running on the mobile device, at least one item of a second product or second product category different from said first product or first product category;
g. adding, to the shopping basket of the application program running on the mobile device, product items in accordance with said first purchase offer;
h. checking out, in the application program, at least one item of said second product or second product category for payment;
i. checking out, in the application program, product items in accordance with said first purchase offer;
j. pressing a button, link, area or object in the application program to thereby request verification of the authorized use of said first purchase offer; and
k. activating an input means of the mobile device to thereby request verification of the authorized use of said first purchase offer.

In embodiments, the method further comprises the following step prior to transmitting said data representing said first purchase offer:
l. obtaining event data representing identified events associated with at least one of said first and said second product or product category, wherein said events are identified by other mobile devices than said mobile device and the event data transmitted in response to the occurrence of the events is received from other mobile devices than said mobile device, and wherein said events include at least one of the events of scanning a barcode, the addition of an item to a shopping basket of the application program, checking out (in the application program) an item for payment and the confirmed purchase of a product item.

In embodiments, the method further comprises the following step prior to transmitting said data representing said first purchase offer:
m. obtaining event data representing identified events, wherein said events are identified by and received from said same mobile device and indicates a certain shopping behavior of the user of the mobile device, and wherein said events include at least one of the events of scanning a barcode, the addition of an item to a shopping basket of the application program, checking out (in the application program) an item for payment and the purchase of a product item.

In embodiments, the method further comprises the step of:
n. constructing/creating said first purchase offer at least partly based on said obtained event data.

In embodiments, said first purchase offer is constructed/created prior to at least one of said step of receiving said barcode or data representing said barcode associated with a physical first product item being offered for sale by the store and receiving event data associated with said first product or first product category, and said first purchase offer is at least partly based on at least one of the historical shopping behavior of the user of the mobile device and event data received from other mobile devices.

In embodiments, said first purchase offer is constructed/created by the control system in response to at least one of the events of receiving said barcode or data representing said barcode associated with a physical first product item being offered for sale by the store and receiving event data associated with said first product or first product category, and said first purchase offer is at least partly based on at least one of the historical shopping behavior of the user of the mobile device and event data received from other mobile devices.

In aspects, the technology disclosed relates to a control system for providing a user of a mobile device with a verification code following a payment transaction including a purchase offer provided to the customers present in a store, said control system is configured to:
a. receive event data indicating the event of a successfully completed payment transaction including the purchase of the product items of a first purchase offer by the user of a mobile device;
b. determine an optically readable code, or data for generating an optically readable code associated with said first purchase offer and/or the products of said first purchase offer; and
c. transmit, to said mobile device and in response to receiving said event data indicating said event of a successfully completed payment transaction, an optically readable code, or data for generating an optically readable code.

In embodiments, said control system is further configured to:
d. receive an image or barcode, or data representing an image or a barcode, from a mobile device;
e. determine that said received image or barcode data is associated with a product item which belongs to a first product or first product category;
f. identify a first purchase offer associated with the first product or first product category; and
g. transmit data representing a first purchase offer to said mobile device.

In embodiments, said control system is configured to perform the following steps prior to conducting the payment transaction:
h. receiving, from the same mobile device, event data indicating that the user of the mobile device has accepted said first purchase offer; and
i. transmitting, from the control system to the same mobile device, an optically readable code or data adapted to be used for generating an optically readable code representing said first purchase offer, wherein said optically readable code, when scanned or read, is adapted to validate or verify that the user of the mobile device is authorized to take advantage of said first purchase offer and proceed to payment in accordance with the price and conditions of said purchase offer, and wherein said transmission of said optically readable code, or data adapted to be used for generating an optically readable code, representing said first purchase offer is performed in response to and triggered by said control system receiving said event data indicating that the user of the mobile device has accepted said first purchase offer.

In embodiments, the control system is further configured to perform the following step prior to transmitting said data representing said first purchase offer:
a. obtaining event data representing identified events, wherein said events are identified by and received from said same mobile device and indicates a certain shopping behavior of the user of the mobile device, and wherein said events include at least one of the events of scanning a barcode, the addition of an item to a shopping basket of the application program, checking out (in the application program) an item for payment and the purchase of a product item.

In embodiments, the control system is further configured to perform the following step prior to transmitting said data representing said first purchase offer:
b. obtaining event data representing identified events, wherein said events are identified by and received from said same mobile device and indicates a certain shopping behavior of the user of the mobile device, and wherein said events include at least one of the events of scanning a barcode, the addition of an item to a shopping basket of the application program, checking out (in the application program) an item for payment and the purchase of a product item.

In embodiments, the control system is further configured to perform the following step prior to transmitting said data representing said first purchase offer:
c. creating said first purchase offer at least partly based on said obtained event data.

In embodiments, said optically readable code, or data adapted to be used for generating an optically readable code, transmitted in response to receiving said event data indicating said event of a successfully completed payment transaction, is adapted to be used for validating or verifying, when scanned by a scanner in a second store or shown to staff members in the second store, that the user of the mobile device is authorized to take advantage of a second purchase offer including at least one product available for sale at the second store.

In embodiments, said optically readable code, or data adapted to be used for generating an optically readable code, transmitted in response to receiving said event data indicating said event of a successfully completed payment transaction, is adapted to be used for deactivating, when scanned or read by a scanner or image recognition device at a self-checkout desk in the store, an alarm tag attached to or associated with the product items of said first purchase offer.

In certain embodiments, the successfully completed payment transaction may then be conducted by use of a digital wallet based mobile phone or smartphone.

In embodiments, said optically readable code, or data adapted to be used for generating an optically readable code, transmitted in response to receiving said event data indicating said event of a successfully completed payment transaction, when scanned or read by a scanner or image recognition device at a self-checkout desk in the store or at the exit gate of the store, is adapted to be used as a gate opener for opening an exit gate. In certain embodiments, the successfully completed payment transaction may then be conducted by use of a digital wallet based mobile phone or smartphone.

In embodiments, said control system is further configured to perform said step of transmitting data representing said first purchase offer to the mobile device in response to receiving said image or barcode data.

In embodiments, said control system is further configured to perform said step of transmitting data representing said first purchase offer to the mobile device in response to receiving event data from the mobile device, and the event data is representing at least one of the actions of the user of the mobile device of adding at least one item of the first product or first product category to the shopping basket of the application program and checking out at least one item of the first product or first product category for payment.

In embodiments, said control system is further configured to perform the following step prior to transmitting said data representing said first purchase offer:
o. transmitting, from said control system to said mobile device, product and/or price information for said first product or first product category, wherein said product and/or price information for said first product is transmitted in response to receiving said barcode or data representing said barcode.

In embodiments, said control system is further configured to perform the following step prior to transmitting said data representing said first purchase offer:
p. obtaining event data representing identified events, wherein said events are identified by and received from said same mobile device and indicates a certain shopping behavior of the user of the mobile device, and wherein said events include at least one of the events of scanning a barcode, the addition of an item to a shopping basket of the application program, checking out (in the application program) an item for payment and the purchase of a product item.

In embodiments, said control system is further configured to perform the following step prior to transmitting said data representing said first purchase offer:
q. obtaining event data representing identified events, wherein said events are identified by and received from said same mobile device and indicates a certain shopping behavior of the user of the mobile device, and wherein said events include at least one of the events of scanning a barcode, the addition of an item to a shopping basket of the application program, checking out (in the application program) an item for payment and the purchase of a product item.

In embodiments, said control system is further configured to perform the following step prior to transmitting said data representing said first purchase offer:
r. constructing/creating said first purchase offer at least partly based on said obtained event data.

In aspects, the technology disclosed relates to an application program installed on a mobile device, said application program is configured to:
a. identify the event of a successfully completed payment transaction, or event data associated with a successfully completed payment transaction, including the purchase of the product items of a first purchase offer by the user of a mobile device; and
b. display an optically readable code in response to identifying said event or event data associated with the successfully completed payment transaction.

In certain aspects, said application program is further configured to perform the following steps prior to displaying said optically readable code:
s. receive, from a control system, data for generating said optically readable code; and
t. generate said optically readable code.

In embodiments, said application program is further configured to:
u. receive data representing a first purchase offer;
v. display image data representing said first purchase offer, wherein said step of displaying is performed in response to said mobile device receiving said image data representing said first purchase offer;
w. initiate a payment transaction including the purchase of product items of said first purchase offer;
x. identify the event of a successfully completed payment transaction including the purchase of the product items of said first purchase offer; and
y. display an optically readable code, wherein said optically readable code is displayed following the step of identifying the event of a successfully completed payment transaction including the purchase of the product items of said first purchase.

In embodiments, said application program is further configured to perform the following steps prior to conducting a payment transaction:
a. identify the event of accepting, by the user of the mobile device, said first purchase offer; and
b. display an optically readable code adapted for validating or verifying that the user of the mobile device is authorized to take advantage of said first purchase offer.

In embodiments, said application program is configured to identify the event of accepting by identifying at least one of the events of:
a. adding, to the shopping basket of the application program running on the mobile device, at least one item of a second product or second product category different from said first product or first product category;
b. adding, to the shopping basket of the application program running on the mobile device, product items in accordance with said purchase offer;
c. checking out, in the application program, at least one item of said second product or second product category for payment;
d. checking out, in the application program, product items in accordance with said purchase offer;
e. pressing a button, link, area or object in the application program to thereby request verification of the authorized use of said purchase offer; and
f. activating an input means of the mobile device to thereby request verification of the authorized use of said purchase offer.

In embodiments, the technology disclosed relates to method for providing a user of a mobile device with a discount and/or a purchase offer including at least one product available to customers in a second store, e.g. belonging to a second store chain, and while the user is present in a first store, e.g. belonging to a first store chain, said method comprising the steps of:
a. transmitting, from the mobile device to the control system, event data representing the at least one event indicating a successfully completed payment transaction for purchasing the at least one product of a first purchase offer available at the first store and provided to the customer's mobile device while present in the first store;
b. receiving, by the control system, said event data representing said at least one event indicating the successfully completed payment transaction; and
c. transmitting, from the control system to the mobile device, data adapted to be used for generating and/or displaying an optically readable code representing a discount or a second purchase offer, wherein said transmission of said data is performed in response to and triggered by said control system receiving said event data.

In embodiments, the technology disclosed relates to method for providing a user of a mobile device with a discount and/or a second purchase offer including at least one product available to customers in a second store and provided to the customers while present in a first store, said method comprising:
a. acquiring or scanning, by an image acquisition component or scanner operatively connected to the mobile device, an image or barcode associated with a physical product item being offered for sale by the first store, wherein said physical product item belongs to a first product or first product category;
b. transmitting, by said mobile device, said image or barcode, or data representing said image or barcode, to a control system which is comprising, or is at least one of operatively coupled to and communicatively connected to, a database;
c. transmitting, from the control system to the mobile device, data representing a first purchase offer;
d. displaying, in a browser or an application program running on the mobile device and on the screen of said mobile device, data representing said first purchase offer, wherein said step of displaying is performed in response to said mobile device receiving said data representing said first purchase offer; and
e. identifying, by the application program running on the mobile device, the at least one event indicating a successfully completed payment transaction including the purchase of the product(s) of said first purchase offer
f. transmitting, from the mobile device to the control system, event data representing the at least one event indicating the successfully completed payment transaction;
g. receiving, by the control system, said event data representing said at least one event indicating the successfully completed payment transaction; and
h. transmitting, from the control system to the mobile device, data adapted to be used for generating and/or displaying an optically readable code representing a discount and/or second purchase offer, wherein said transmission of said data is performed in response to and triggered by said control system receiving said event data indicating the successfully completed payment transaction including the purchase of the product(s) of said first purchase offer; and
i. receiving, by the mobile device, data adapted to be used for generating and/or displaying an optically readable code representing said discount and/or second purchase offer; and
j. displaying, by the mobile device, the optically readable code representing said purchase offer, wherein said optically readable code is adapted to validate or verify, when scanned, read or shown to a staff member in the second store, that the user is authorized to take advantage of said discount and/or second purchase offer.

In embodiments, the technology disclosed relates to method for providing a user of a mobile device with a discount or second purchase offer including at least one product available to customers in a second store and while the user is present in a first store where the customer's mobile device received a first purchase offer, said method comprising:
a. acquiring or scanning, by an image acquisition component or scanner operatively connected to the mobile device, an image or barcode associated with a physical product item being offered for sale by the first store, wherein said physical product item belongs to a first product or first product category;
b. transmitting, by said mobile device, said image or barcode, or data representing said image or barcode, to a control system which is comprising, or is at least one of operatively coupled to and communicatively connected to, a database;
c. transmitting, from the control system to the mobile device, data representing the first purchase offer;
d. displaying, in a browser or an application program running on the mobile device and on the screen of said mobile device, data representing said first purchase offer, wherein said step of displaying is performed in response to said mobile device receiving said data representing said first purchase offer; and
e. identifying, by the application program running on the mobile device, the at least one event indicating a successfully completed payment transaction including the purchase of the product(s) of said first purchase offer; and
f. displaying, by the mobile device, an optically readable code representing a discount and/or a second purchase offer, wherein said display of said optically readable code is displayed in response to and/or triggered by said identifying of the at least one event indicating the successfully completed payment transaction including the purchase of the product(s) of said first purchase offer, wherein said optically readable code is adapted to validate or verify, when scanned, read or shown to a staff member in the second store, that the user is authorized to take advantage of said discount and/or second purchase offer.

In certain aspects, the technology disclosed is directed to facilitating the provision of discounts and purchase offers in real-time, and more particularly to methods and a system for offering an enhanced shopping experience in a store based on event data reflecting the shopping behaviour of the customer receiving the purchase offer as well as event data received from other customers, i.e. other customer's mobile devices, and which indicates the shopping behaviour of these other customers. The enhanced shopping experience may then include that a customer who is present in a first store and after a successfully completed payment transaction, including the purchase of product(s) pf a first purchase offer, receives an optically readable code for validating or verifying that the customer is authorized to take advantage of a discount and/or second purchase offer which may be used for purchasing physical products available for sale in a second store different from the first store, e.g. a second store which belongs to a different store chain than the first store.

In other aspects, the technology disclosed is directed to the task of validating or verifying that a customer is authorized to take advantage of a discount and/or second purchase offer, and more particularly to method and a system for capturing and acting on event data obtained at a first store to provide secure verification of the customer's authorization to take advantage of a discount and/or second purchase offer including product(s) which are not available for sale at the first store, but only available at a second store.

In embodiments, the displayed data representing the first purchase offer may then include the purchase of both a first product which physical product item associated barcode was scanned or read in the store by the mobile device receiving the purchase offer and the purchase of an product item of at least one second product which associated barcode the mobile device was not scanned or read before receiving the first purchase offer. After receiving optically readable code in response to the successfully completed payment transaction including the purchase of product(s) of the first purchase offer, the customer enters the second store and orders or fetch at least one second product of the second purchase, or associated with said discount, to the cash register desk or and/or a self-checkout terminal of the second store, where the optically readable code image data representing the discount and/or second purchase offer is shown or scanned/read by a device to validate or verify that the user of the mobile device is authorized to take advantage of the discount and/or second purchase offer.

In embodiments, the provided purchase offer, including at least one item of the first product, which associated barcode was scanned before receiving the first purchase offer, and at least one item of a second product different from the first product, where the combined purchase offer is at least partly based on previously received event data, i.e. received before the customer entered the store. The combined offer, including both the first product which physical product item's associated barcode label was scanned or read by the mobile device and the second product may then be constructed/created at least partly based on identified and/or received events and/or event data obtained before the customer entered the first store, where the events and/or event data was identified by and/or received from at least one of the customer's own mobile device and the mobile devices of other customers. The previously identified and/or received events and/or event data may then be associated with previously performed purchases of items of the first product and of the second product, e.g. combined or aggregated purchases including at least one item of the first product and at least one item of the second product.

In aspects, the system, methods adapted for validly and computer program products of the technology disclosed are adapted for securely validating or verifying, to the staff member at the second store and/or the cashier system of the second store before payment, that a customer, or user of a mobile device, can take advantage of the discount and/or second purchase offer, e.g. a customized or personalized second purchase offer, where the discount and/or second purchase offer is adapted to be used in the second store but was provided to the customer in response to identified events associated with the customer's mobile device and while the customer is present in the first store.

In embodiments, the technology disclosed is directed to validating or verifying that a customer is authorized to take advantage of a purchase offer by providing a scannable and/or readable verification code, and more particularly to method and a system for capturing and acting on event data obtained at a first store to provide secure verification of the customer's authorization to take advantage of the purchase offer by providing the scannable and/or readable verification code in response to events identified by the application program running on the mobile device. In embodiments and after receiving an optically readable code which contents at least partly represents the discount and/or second purchase offer, the customer typically needs to order at least one second product at, or fetch the at least one physical product item of the second purchase offer and then bring the at least one physical item to, the cash register desk or and/or a self-checkout terminal of the second store. At the desk and/or terminal of the second store, the image data representing the purchase offer, e.g. the optically readable code which contents represents the purchase offer, is displayed on the screen of the mobile device and is then shown to a staff member at the cash register desk of the second store, or is scanned or read by a device. The scanning or reading may performed by using a device communicatively connected to the cashier system of the second store, thereby validating or verifying that the user of the mobile device is authorized to take advantage of the discount and/or second purchase offer comprising the at least one ordered product at the cash register desk of the second store, or physical product item brought to the cash register desk or and/or a self-checkout terminal of the second store.

In aspects, the technology disclosed is directed to a system and a method for providing a user of a mobile device with the first purchase offer including at least one product available to customers in the first store and while the user is present in the first store, said method comprising:
a. acquiring or scanning, by an image acquisition component or scanner operatively connected to the mobile device, an image or barcode associated with a physical product item being offered for sale by the store, wherein said physical product item belongs to a first product or first product category;
b. transmitting, by said mobile device, said image or barcode, or data representing said image or barcode, to a control system which is comprising, or is at least one of operatively coupled to and communicatively connected to, a database;
c. transmitting, from the control system to the mobile device, data representing a first purchase offer;
d. displaying, in a browser or an application program running on the mobile device and on the screen of said mobile device, data representing said first purchase offer, wherein said step of displaying is performed in response to said mobile device receiving said data representing said first purchase offer; and
e. identifying, by the application program running on the mobile device, at least one event indicating the successfully completed payment transaction including the purchase of the product(s) of said first purchase offer.

In embodiments, the technology disclosed is directed to a system configured to and a method which comprises the step of:
a. displaying, by the application program running on said mobile device, an optically readable code which content is representing a discount and/or a second purchase offer different from said first purchase offer and including products different from the products of said first purchase offer.

In embodiments, the first purchase offer is including at least the purchase of an item of said first product or first product category.

In embodiments, the first purchase offer is including at least the purchase of an item of a second product or second product category different from said first product or first product category.

In embodiments, the technology disclosed is directed to a system configured to and a method which comprises the step of:
a. transmitting, from said mobile device to said control system, event data representing said at least one event indicating the acceptance of the first purchase offer;
b. receiving, by the control system, said event data representing said at least one event indicating the acceptance of said first purchase offer; and
c. transmitting, from the control system to the mobile device, data adapted to be used for generating an optically readable code representing said first purchase offer or reflecting the items currently in the shopping basket which includes the product items of said first purchase offer, wherein said transmission of said data is performed in response to and triggered by said control system receiving said event data.

In aspects, the technology disclosed is directed to a system and a method for providing a user of a mobile device with said first purchase offer including at least one product available to customers in said first store and while the user is present in the first store, said method comprising:
a. scanning, by a scanner operatively connected to the mobile device, a barcode associated with a physical product item being offered for sale by the store, wherein said physical product item belongs to a first product or first product category;
b. transmitting, by said mobile device, said barcode, or data representing said barcode, to a control system which is comprising, or is at least one of operatively coupled to and communicatively connected to, a database;
c. transmitting, from the control system to the mobile device, data representing said first purchase offer;
d. displaying, in a browser or an application program running on the mobile device and on the screen of said mobile device, data representing said first purchase offer, wherein said step of displaying is performed in response to said mobile device receiving said data representing said first purchase offer; and
e. identifying, by the application program running on the mobile device, at least one event indicating the acceptance, by the user of the mobile device, of said first purchase offer.

In embodiments, the technology disclosed is directed to a system configured to and a method which comprises the step of:
a. displaying, by the application program running on said mobile device, an optically readable code which content is representing said first purchase offer or is reflecting the list of items currently in the shopping basket which includes the product items of said first purchase offer.

Embodiments of the technology disclosed are directed to a system, a backend/control system, an application program installed on a mobile device and methods for providing, by the backend/control system, a discount and/or second purchase offer and then transmitting an optically readable/scannable verification code for validating or verifying the discount and/or second purchase offer, following a successfully completed payment transaction including the purchase of the product(s) of a first purchase offer different from the product(s) of the second purchase offer.

In aspects, the technology disclosed relates to a control system for providing a user of a mobile device with purchase offers including products available to customers in a store and while the user is present in the store, said control system is comprising or is at least one of operatively connected and communicatively coupled to a database and is configured to:
a. receive an image or barcode, or data representing an image or barcode associated with a physical first product item being offered for sale by the store, from a mobile device;
b. determine that said received image or barcode data belongs to a first product or first product category;
c. identify a first purchase offer associated with the first product or first product category;
d. transmit, to said mobile device and in response to receiving said image or barcode data, data representing said first purchase offer;
e. receive, from said mobile device, event data transmitted in response to the event of indicating a successfully completed payment transaction including the at least one product of the first purchase offer; and
f. transmit, from the control system to said mobile device, an optically readable code representing a discount and/or second purchase offer or data adapted to be used for generating an optically readable code representing said discount and/or second purchase offer, wherein said optically readable code is adapted to validate or verify, when scanned or read, that the user of the mobile device is authorized to take advantage of said discount and/or second purchase offer and proceed to payment in accordance with the price and conditions of said discount and/or second purchase offer.

In embodiments, the technology disclosed relates to a control system for providing a user of a mobile device with purchase offers including products available to customers in a store and while the user is present in the store, said control system is configured to:
a. receive event data from a mobile device;
b. transmit, in response to receiving said event data, data representing a first purchase offer to the same mobile device;
c. receive, from the same mobile device, event data indicating that the user of the mobile device has completed a payment transaction including the purchase of the product(s) of said first purchase offer; and
d. transmit, from the control system to the same mobile device, data adapted to be used for generating an optically readable code representing a discount and/or second purchase offer different from said first purchase offer, wherein said optically readable code, when scanned or read, is adapted to validate or verify that the user of the mobile device is authorized to take advantage of said discount and/or second purchase offer and may proceed to payment in accordance with the price and conditions of said discount and/or second purchase offer, and wherein said transmission of said data is performed in response to and triggered by said control system receiving said event data indicating that the user of the mobile device has completed a payment transaction including the purchase of the product(s) of said first purchase offer.

In embodiments, the optically readable code, which is displayed on the customer's mobile device, may, in addition or instead, be used for opening an exit gate and/or deactivating an alarm tag attached to a physical product item at the self-checkout desk in the (first or second) store and/or at the exit gate area or desk of the (first or second) store. The scanning or reading of the optically readable code, e.g. the scanning or reading by a scanner or image acquisition or recognition device at the self-checkout desk in the store and/or at the exit gate of the store, may then (automatically) open the exit gate and/or (automatically) deactivate the an alarm tag attached to the physical product item. In certain embodiments, the successfully completed payment transaction may then have been conducted by use of a digital wallet based mobile phone or smartphone.

In aspects, the technology disclosed relates to a control system for providing a user of a mobile device with purchase offers including products available to customers in a store and while the user is present in the store, said control system is comprising or is at least one of operatively connected and communicatively coupled to a database and is configured to:
a. receive an image or barcode, or data representing an image or barcode associated with a physical first product item being offered for sale by the store, from a mobile device;
b. determine that said received image or barcode data belongs to a first product or first product category;
c. identify a first purchase offer associated with the first product or first product category;
d. transmit, to said mobile device and in response to receiving said image or barcode data, data representing said first purchase offer;
e. receive, from said mobile device, event data transmitted in response to the event of indicating a successfully completed payment transaction including the at least one product of the first purchase offer; and
f. transmit, from the control system to said mobile device, an optically readable code adapted for at least one of opening an exit gate and deactivating an alarm tag attached to a physical product item of a product of the first purchase offer or data adapted to be used for generating an optically readable code for at least one of opening an exit gate and deactivating an alarm tag attached to a physical product item of a product of the first purchase offer, wherein said optically readable code, when scanned or read, is adapted to at least one of open an exit gate and deactivate an alarm tag attached to a physical product item of a product of the first purchase offer.

In embodiments, the technology disclosed relates to method for providing a user of a mobile device with a purchase offer including at least one product available to customers in a store while the user is present in the store, said method comprising the steps of:
a. transmitting, from the mobile device to the control system, event data representing the at least one event indicating a successfully completed payment transaction for purchasing the at least one product of a purchase offer available at the store and provided to the customer's mobile device while present in the store;
b. receiving, by the control system, said event data representing said at least one event indicating the successfully completed payment transaction; and
c. transmitting, from the control system to the mobile device, data adapted to be used for generating and/or displaying an optically readable code for opening an exit gate and/or deactivating an alarm tag attached to a physical product item, wherein said transmission of said data is performed in response to and triggered by said control system receiving said event data.

In embodiments, the technology disclosed relates to method for providing a user of a mobile device with a purchase offer including at least one product available at the store and provided to the customers while present in the store, said method comprising:
a. acquiring or scanning, by an image acquisition component or scanner operatively connected to the mobile device, an image or barcode associated with a physical product item being offered for sale by the store;
b. transmitting, by said mobile device, said image or barcode, or data representing said image or barcode, to a control system which is comprising, or is at least one of operatively coupled to and communicatively connected to, a database;
c. transmitting, from the control system to the mobile device, data representing a purchase offer;
d. displaying, in a browser or an application program running on the mobile device and on the screen of said mobile device, data representing said purchase offer, wherein said step of displaying is performed in response to said mobile device receiving said data representing said purchase offer; and
e. identifying, by the application program running on the mobile device, the at least one event indicating a successfully completed payment transaction including the purchase of the product(s) of said purchase offer
f. transmitting, from the mobile device to the control system, event data representing the at least one event indicating the successfully completed payment transaction;
g. receiving, by the control system, said event data representing said at least one event indicating the successfully completed payment transaction; and
h. transmitting, from the control system to the mobile device, data adapted to be used for generating and/or displaying an optically readable code adapted for opening an exit gate and/or deactivating an alarm tag attached to a physical product item of a product of the purchase offer, wherein said transmission of said data is performed in response to and triggered by said control system receiving said event data indicating the successfully completed payment transaction including the purchase of the product(s) of said first purchase offer; and
i. receiving, by the mobile device, data adapted to be used for generating and/or displaying an optically readable code for opening an exit gate and/or deactivating an alarm tag attached to a physical product item of a product of the purchase offer; and
j. displaying, by the mobile device, the optically readable code, wherein said optically readable code, when scanned or read, is adapted for opening an exit gate and/or deactivating an alarm tag attached to a physical product item of a product of the purchase offer.

In embodiments, the technology disclosed relates to method for providing a user of a mobile device with a purchase offer including at least one product available to customers in the store and while the user is present in the store, said method comprising:
a. acquiring or scanning, by an image acquisition component or scanner operatively connected to the mobile device, an image or barcode associated with a physical product item being offered for sale by the first store;
b. transmitting, by said mobile device, said image or barcode, or data representing said image or barcode, to a control system which is comprising, or is at least one of operatively coupled to and communicatively connected to, a database;
c. transmitting, from the control system to the mobile device, data representing the purchase offer;
d. displaying, in a browser or an application program running on the mobile device and on the screen of said mobile device, data representing said purchase offer, wherein said step of displaying is performed in response to said mobile device receiving said data representing said purchase offer; and
e. identifying, by the application program running on the mobile device, the at least one event indicating a successfully completed payment transaction including the purchase of the product(s) of said purchase offer; and
f. displaying, by the mobile device, an optically readable code adapted to be used for opening an exit gate and/or deactivating an alarm tag attached to a physical product item of a product of the purchase offer, wherein said display of said optically readable code is displayed in response to and/or triggered by said identifying of the at least one event indicating the successfully completed payment transaction including the purchase of the product(s) of said purchase offer.

In embodiments, the first purchase offer transmitted in step b above includes at least the purchase of an item of a second product or second product category different from said first product or first product category.

In embodiments, the technology disclosed relates to a method comprising the following steps prior to the step of identifying the successfully completed payment transaction:
a. transmitting, from said mobile device to said control system, event data representing the at least one event indicating the acceptance of said purchase offer;
b. receiving, by the control system, said event data representing said at least one event indicating the acceptance of said purchase offer;
c. transmitting, from the control system to the mobile device, data adapted to be used for generating an optically readable code representing said purchase offer or reflecting the items currently in the shopping basket which includes the product items of said purchase offer, wherein said transmission of said data is performed in response to and triggered by said control system receiving said event data representing said at least one event indicating the acceptance of said purchase offer;
d. generating, by the application program running on said mobile device, an optically readable code corresponding to said data adapted to be used for generating an optically readable code representing said purchase offer or reflecting the items currently in the shopping basket which includes the product items of said purchase offer; and
e. displaying, by the application program running on said mobile device and on the screen of said mobile device, said optically readable code representing said purchase offer, wherein said optically readable code, when scanned or read, is adapted to validate or verify that the user of the mobile device is authorized to take advantage of said purchase offer and may proceed to payment in accordance with the price and conditions of said purchase offer.

In certain embodiments, the technology disclosed relates to a control system for providing a user of a mobile device with purchase offers including products available to customers in a retail store and while the user is present in the retail store, said control system is comprising or is at least one of operatively connected and communicatively coupled to a database and is configured to perform the following steps prior to the completion of the successfully completed payment transaction:
a. receiving a scanned barcode, or data representing a barcode, from a mobile device;
b. determining that said received barcode data is associated with a physical first product item being offered for sale by the retail store and that said first product item belongs to a first product or first product category;
c. identifying a purchase offer associated with the first product or first product category;
d. transmitting, in response to receiving said barcode data, data representing a purchase offer to the same mobile device, where said purchase offer include at least the purchase of an item of a second product or second product category different from said first product or first product category;
e. receiving, from the same mobile device, event data indicating that the user of the mobile device has accepted the purchase offer; and
f. transmitting, from the control system to the same mobile device, data adapted to be used for generating an optically readable code representing said purchase offer, wherein said optically readable code, when scanned or read, is adapted to validate or verify that the user of the mobile device is authorized to take advantage of said purchase offer and proceed to payment in accordance with the price and conditions of said purchase offer, and wherein said transmission of said data is performed in response to and triggered by said control system receiving said event data indicating that the user of the mobile device has accepted the purchase offer.

In certain embodiments of the methods, systems and computer program products of the technology disclosed, the scanning or reading of the displayed optically readable code may automatically initiate a payment transaction for purchasing the at least one product item according to the price and conditions of the purchase offer provided to the customer's mobile device.

In embodiments, the event data received by the control system represents an event indicating that the user of the mobile device has accepted the purchase offer includes at least one of the events of:
a. adding, to the shopping basket of the application program running on the mobile device, at least one item of a second product or second product category different from said first product or first product category;
b. adding, to the shopping basket of the application program running on the mobile device, product items in accordance with said purchase offer;
c. checking out, in the application program, at least one item of said second product or second product category for payment;
d. checking out, in the application program, product items in accordance with said purchase offer;
e. pressing a button, link, area or object in the application program to thereby request verification of the authorized use of said purchase offer; and
f. activating an input means of the mobile device to thereby request verification of the authorized use of said purchase offer.

In embodiments, said (first) purchase offer transmitted by the control system include at least the purchase of an item of a second product or second product category different from said first product or first product category.

In embodiments, the technology disclosed relates to control system for providing a user of a mobile device with purchase offers including products available to customers in a store and while the user is present in the store, said control system is configured to:
a. receive a scanned barcode, or data representing a barcode, from a mobile device;
b. determine that said received barcode data is associated with a physical first product item being offered for sale by the retail store;
c. transmit, in response to receiving said barcode data, data representing a purchase offer to the same mobile device;
d. receive, from the same mobile device, event data indicating that the user of the mobile device has completed a payment transaction including the purchase of the product(s) of said purchase offer; and
e. transmit, from the control system to the same mobile device, data adapted to be used for generating an optically readable code for opening a gate, deactivating an alarm tag attached to the physical product item of a product of said purchase offer and/or representing a second purchase offer, wherein said optically readable code, when scanned or read, is adapted for opening a gate, deactivating an alarm tag attached to the physical product item of a product of said purchase offer and/or validate or verify that the user of the mobile device is authorized to take advantage of said second purchase offer and may at least one of exit the store with the physical product items and/or proceed to payment in accordance with the price and conditions of said second purchase offer, and wherein said transmission of said data is performed in response to and triggered by said control system receiving said event data indicating that the user of the mobile device has successfully completed the payment transaction.

In aspects, the technology disclosed relates to an application program (APP) installed on a mobile device, said application program is configured to:
a. receive data representing a purchase offer;
b. display, in the application and on the screen of the mobile device, data representing said purchase offer;
c. identify the event of accepting, by the user of the mobile device, said purchase offer; and
d. display an optically readable code adapted for opening an exit gate at the store, deactivating an alarm tag attached to the physical product item of a product of said purchase offer and/or validating or verifying that the user of the mobile device is authorized to take advantage of a second purchase offer in a second store different from the store where said (first) purchase offer was received by the mobile device.

In embodiments, the application program is further configured to:
e. receive, from a control system, data adapted for at least one of generating and displaying said optically readable code; and
f. display, in the application and on the screen of the mobile device, said optically readable code adapted for opening an exit gate at the store, deactivating an alarm tag attached to the physical product item of a product of said purchase offer and/or validating or verifying that the user of the mobile device is authorized to take advantage of a second purchase offer in a second store different from the store where said (first) purchase offer was received by the mobile device.

In certain embodiments, the application program is further configured to identify the at least one event indicating the acceptance of the purchase offer by the user by identifying at least one of the events of:
g. adding, to the shopping basket of the application program running on the mobile device, at least one item of a second product or second product category different from said first product or first product category;
h. adding, to the shopping basket of the application program running on the mobile device, product items in accordance with said purchase offer;
i. checking out, in the application program, at least one item of said second product or second product category for payment;
j. checking out, in the application program, product items in accordance with said purchase offer;
k. pressing a button, link, area or object in the application program to thereby request verification of the authorized use of said purchase offer; and
l. activating an input means of the mobile device to thereby request verification of the authorized use of said purchase offer.

According to embodiments, the method according to the technology disclosed further comprises the following step prior to transmitting said data representing said first purchase offer:
a. obtaining event data representing identified events, wherein said events are identified by and received from said same mobile device and indicates a certain shopping behavior of the user of the mobile device, and wherein said events include at least one of the events of acquiring an image of a physical product item, the addition of an item to a shopping basket of the application program, checking out (in the application program) an item for payment and the purchase of a product item.

According to embodiments, the method according to the technology disclosed further comprises constructing/creating the first purchase offer at least partly based on previously obtained event data, i.e. event data obtained before the customer enters the store and scan a barcode label associated with, or identifying, a physical product item.

In certain embodiments, the purchase offer is constructed/created prior to at least one of said step of receiving said acquired image or data representing said acquired image associated with a physical first product item being offered for sale by the retail store and receiving event data associated with said first product or first product category, and wherein said first purchase offer is at least partly based on at least one of event data reflecting the historical shopping behavior of the user of the mobile device and event data received from other mobile devices.

According to embodiments, the method further comprising the steps of:
a. transmitting, from the control system to the mobile device, data adapted to be used for generating an optically readable code adapted for opening an exit gate at the store, deactivating an alarm tag attached to the physical product item of a product of said purchase offer and/or validating or verifying that the user of the mobile device is authorized to take advantage of a second purchase offer in a second store different from the store where said (first) purchase offer was received by the mobile device, wherein said transmission of said data is performed in response to and triggered by said control system receiving event data transmitted in response to identifying at least one event indicating a successfully completed payment transaction;
b. generating, by the application program running on said mobile device, an optically readable code corresponding to said data adapted to be used for generating an optically readable code representing said purchase offer; and
c. displaying, in the application program running on said mobile device and on the screen of said mobile device, said optically readable code for opening an exit gate at the store, deactivating an alarm tag attached to the physical product item of a product of said purchase offer and/or validating or verifying that the user of the mobile device is authorized to take advantage of a second purchase offer in a second store different from the store where said (first) purchase offer was received by the mobile device.

According to embodiments, the method according to the technology disclosed further comprises the step of:
a. scanning, by a scanner operatively coupled to the cashier system of the retail store, said optically readable code, thereby validating or verifying that the user of the mobile device is authorized to take advantage of said purchase offer and proceed to payment.

According to embodiments, the method according to the technology disclosed further comprises:
a. conducting a payment transaction for purchasing the product item(s) of said purchase offer, wherein said payment transaction is conducted following said scanning of said optically readable code representing said first purchase offer is validating or verifying that the user of the mobile device is authorized to take advantage of said first purchase offer.

### BRIEF DESCRIPTION OF DRAWINGS

Preferred embodiments of a system according to the technology disclosed will be described more in detail below with reference to the accompanying drawings wherein:

FIG. 1 illustrates a system according to embodiments of the technology disclosed.

FIG. 2 is a flowchart illustrating a process according to embodiments of the technology disclosed.

FIG. 3 is a flowchart illustrating a process according to embodiments of the technology disclosed.

FIG. 4 is a flowchart illustrating a process according to embodiments of the technology disclosed.

FIG. 5 is a flowchart illustrating a process according to embodiments of the technology disclosed.

### DETAILED DESCRIPTION

In the drawings, similar details are denoted with the same reference number throughout the different embodiments. In the various embodiments of the system according to the technology disclosed, the different subsystems are denoted. The “boxes”/subsystems shown in the drawings are by way of example only and can within the scope of the technology disclosed be arranged in any other way or combination.

Internet-based retail merchants have utilized electronic shopping carts on their ecommerce websites to allow consumers to shop throughout the site and check-out once completed. One advantage of the online cart is that merchants can capture virtually any consumer events as each action creates a unique record, e.g. a HTTP event, database transaction, script execution, or other data processing result.

Many of these events, such as events indicating the acceptance of a purchase offer provided to the customer's mobile device or the event of conducting a payment transaction including a purchase offer provided to the customer's mobile device, are simply not obtained by the backend system, and are therefore typically not captured as part of the in-store shopping experience. Furthermore, there is no solution available today where a backend system is capturing event data and providing an optically readable code adapted for validating or verifying that the customer is authorized to take advantage of a purchase offer in response to events identified by a mobile application program (APP) running on a mobile device.

Another example of such an event is the adding of a second product, which is not scanned by the customer, to an electronic shopping cart event where the second product is a product item of a purchase offer provided in response to the scanning of a barcode associated only with a first product item of the purchase offer. On online sales, a shopping cart describes an event, or series of events, during which a consumer selects a first item places it in their electronic shopping cart, effectively adding the item to their order. For example, a consumer may add the second product item to their cart following the receipt of the purchase offer, and then complete a transaction including both the first and the second product of the purchase offer.

Other events, such as the payment transaction including the purchase of product(s) of a purchase offer, is also not captured as part of the offline shopping experience. Furthermore, there is no solution available today for a backend system, e.g. purchase server, of capturing and acting, in real-time, in response to event data transmitted in response to an identified completed payment transaction including the purchase of product(s) of a purchase offer provided to the customer's mobile device while present in the store.

The inventors have recognized and appreciated that the use of personal, mobile devices as point-of-sale (“POS”) apparatus provides numerous opportunities to enhance the in-store shopping experience for consumers and allows merchants and brand companies to capture and analyze data previously not accounted for.

Using the techniques and systems described herein, merchants will gain access to data related to complete and incomplete purchases and be able to offer more flexible and validly verified purchase offers to consumers shopping in-store. Unlike online shopping experiences during which a consumer's interaction with a product is limited to viewing on a screen, in-store shopping allows a consumer to pick up, touch and inspect a product. For example, a consumer may pick up and scan an item using her mobile device to learn more information about the product (price, discounts, warranty, ratings, delivery costs and options, etc.) and decide to check-out or add the product to the shopping basket in the mobile application program running on the mobile device.

The present invention is generally directed to a system, methods and computer program products for dynamically providing discount and subsequent purchase offers in response to a completed payment transaction and. In various embodiments, the discounts or subsequent purchase offers are made available to the customer in the form of optically readable codes displayed on the customer's mobile device.

An exemplary control system, or backend system, is configured to receive, from a consumer's mobile device, event data indicating that the consumer has completed a payment transaction including the purchase of at least one product of a purchase offer available at a first store and, in response, transmit an optically readable code representing a discount and/or a subsequent purchase offer.

In various embodiments, the optically readable code may then be used for validating or verifying that the customer is authorized to take advantage of the discount and/or second purchase offer in a second store different from the first store, and/or may be used as the means for leaving the first store by validating or verifying the successfully completed payment transaction, e.g. by the automatic opening of an exit gate and/or deactivating an alarm tag attached to the physical product items at the self-checkout desk in the first store and/or at the exit gate of the first store.

As mentioned above, there is no solution available today for providing in-store purchase offers and subsequently validating or verifying, in real-time, that the customer is authorized to take advantage of purchase offers accepted by the customer while in-store. In particular, there are no solution available today where a backend/control system is used for validating or verifying that a user of a mobile device is authorized to take advantage of a purchase offer provided by the same backend/control system in response to events related to the identification of physical product items available in the store, and where the events are performed by the customer while the customer is present in the store and identified by a mobile application program (APP) running on the customer's mobile device. The events may, for example, represent decisions made by the customer of conducting a payment transaction including product(s) of a purchase offer provided to him while present in the store, acquiring an image associated with a first physical product item available for sale in the store and proceeding with a purchase offer presented in real-time to the customer while in-store, where the purchase offer, which is displayed on the user's mobile device, includes at least one second product or product category available for sale in the store and which is different from the first product or product category to which the first physical product item belongs.

Decisions which are made by the customer, i.e. the user of the mobile device, not only provides valuable information to the retailer and the brand, but also provide opportunities to turn knowledge about a shown interest about a first product into a subsequent or aggregate purchase including a second product, e.g. event data or information related to a first product which is obtained by a backend system in real-time while the customer is in the store, e.g. identification of occurred events reflecting the customer's interest in proceeding with purchasing a first product while the customer is present in the store, may be used to construct/create and/or present an purchase offer in real-time to the customer which comprises a subsequent, combined or aggregate purchase offer including the additional purchase of a second product, e.g. at a discounted price.

In aspects, the technology disclosed relates to a system, methods and computer program products for providing a user of a mobile device with an optically readable code following a successfully payment transaction including the purchase of the at least one product of a purchase offer which was previously provided to the customers present in a store. The optically readable code may then be displayed on the display of the mobile device following the identifying of at least one event indicating a successfully completed payment transaction for purchasing the at least one product of the purchase offer.

In aspects, the technology disclosed relates to a system, methods and computer program products for providing a user of a mobile device with an optically readable code following a successfully payment transaction including the purchase of the at least one product of a purchase offer which was previously provided to the customers present in a store, where the optically readable code is displayed on the display of the mobile device in response to the step of identifying at least one event indicating the successfully completed payment transaction.

In aspects, the technology disclosed relates to a system, methods and computer program products for providing a user of a mobile device with an optically readable code following a successfully payment transaction including the purchase of the at least one product of a purchase offer which was previously provided to the customers present in a store, where the optically readable code is displayed on the display of the mobile device in response to obtained or received event data indicating the successfully completed payment transaction.

In embodiments, the payment transaction is conducted with the mobile device, e.g. a digital wallet based mobile phone or smartphone, and the at least one event indicating the successfully completed payment transaction is identified by the mobile device. In certain embodiments, event data is transmitted from the mobile device to a backend system, or control system, following the identifying of the successfully completed payment transaction and the mobile device receives, in response, an optically readable code, or data adapted for generating or displaying an optically readable code from the backend system. In general, a digital wallet, also known as “e-Wallet”, refers to an electronic device, online service, or software program that allows an one party to make electronic transactions with another party bartering digital currency units for goods and services. This may include purchasing items using a smartphone to purchase something at a store. Money may be deposited in the digital wallet prior to any transactions or, in other cases, an individual's bank account can be linked to the digital wallet. A digital wallet may have both a software and information component. Secure and fair electronic payment systems are important issue. The software provides security and encryption for the personal information and for the actual transaction.

In embodiments, the payment transaction is conducted without any direct involvement by the mobile device and the at least one event indicating the successfully completed payment transaction is identified by a staff member and/or an application program, e.g. a store APP, running on a separate communication device from the mobile device. The event data may then be transmitted from the separate communication device to a backend system, or control system, following the identifying of the successfully completed payment transaction and the mobile device may, in response to the backend system receiving the event data from the separate communication device, receive, from the backend system, an optically readable code or data adapted for generating and/or displaying an optically readable code on the mobile device. The separate communication device may then be a computer, a PDA, a tablet, a mobile phone or any other communication device configured to transmit event data to the backend system, and which may be operated by a staff member, and the payment transaction may then be conducted by use of the separate communication device and/or the cashier system of the store.

The technology disclosed is generally directed to systems, methods and computer program products for providing in-store product information, discounts and purchase offers. According to different example embodiments, the control system, or backend system, is configured to receive, from a consumer's mobile device, event data indicating the consumer's interest in purchasing products available at a store and then subsequently provide product information, discounts and purchase offers based on previously obtained event data, and an optically readable code for verification in the store. In embodiments, an optically readable code is displayed on the customer's mobile device in response to an event identified by an application program running on the customer's mobile device, where the contents of each optically readable code provided to a customer is adapted to be used for validating or verifying that the customer is authorized to take advantage of a certain purchase offer, and/or may be used for opening an exit gate or deactivating an alarm tag attached to a physical product item in the store. In embodiments, the present invention relates to the acquisition of an image identifying a first product and, in response to the acquired image, event data representing the event of acquiring the image and/or a subsequent event identified by the application program, the consumer is provided with a purchase offer including at least a second product different from the first product identified by the acquired image.

The system, methods and computer program products of the technology disclosed provides the customer with purchase offers while the customer is present in a store in which products of the purchase offer are available.

In various embodiments, the discount or subsequent purchase offers are made available to the customer in the form of optically readable codes displayed on the customer's mobile device. The discounts, or coupons, can be made available online in the form of codes (e.g., alphanumeric codes, bar codes, quick response (QR) codes, etc.). According to the technology disclosed, the discounts, or coupons, will be referred to herein as coupon codes and can include, but are not limited to, promotional codes, discount codes, key codes, voucher codes, reward codes, and/or other coupon indicators. Coupon codes can provide a discount or incentive such as a percentage discount, dollar amount deducted from the price, free shipping, bonus or additional item, and/or another incentive to encourage consumers to purchase specific products and/or to purchase from specific retailers.

The optically readable code may, for example, be a matrix barcode (QR code), a universal product code (UPC), a three-dimensional barcode, or European Article Number (EAN).

A QR code is one of the most well-known kinds of 2D barcodes. QR codes are designed from a pattern of black squares configured on a white background. The code can retain data much like a regular barcode you see on an article of clothing or on food products that are scanned at the checkout counter for information about price and other data. The QR code pattern has the possibility of retaining much more data than typical barcodes. The kind of information and size of the code determine how much data each code can hold.

Certain examples of the technology disclosed provide a control system including a processor configured to receive a trigger in the form of event data to initiate a purchase offer or discount code query in response to or based at least in part on the receiving of event data which was transmitted in response to the identifying of a successfully completed payment transaction including the purchase of the at least one product item of a previously provided purchase offer. The example control system may include at least one engine configured to dynamically create subsequent purchase offers and discount codes in response to receiving event data from mobile devices. The example control system may also include a validation engine configured to search and retrieve subsequent purchase offers and discount codes. An example engine may be configured to provide one or more identified subsequent purchase offers or discounts in the form of an optically readable code to a target mobile device to thereby determine the validity of each identified subsequent purchase offer or discount. The example processor is to dynamically provide subsequent purchase offer and/or discounts in the form of optically readable codes presented on a customer's mobile device in response to the determining of a successfully completed payment transaction including a previously provided purchase offer. The optically readable code, when viewed, scanned or read, determines the validity of the subsequent purchase offer or discount and may be used for validating or verifying to a computer unit, cashier system and/or staff member in a store that the user of a mobile device displaying the optically readable code is authorized to take advantage of the subsequent purchase offer or discount.

Certain examples provide a method including initiating, by the control system and based on a trigger in the form of received event data, a subsequent purchase offer or discount query based at least in part on the received event data. The example method includes searching for and retrieving subsequent purchase offer and discounts using a processor. The example method includes providing, using the processor without further user input, an identified subsequent purchase offer or discount in the form of an optically readable code to a customer's mobile device, where the optically readable code, when scanned or read, determines the validity of the subsequent purchase offer or discount. The example method includes dynamically providing one or more purchase offers or discounts to a customer's mobile device, or a group of customer's mobile device, in response to receiving, by the control system, event data representing the identification of a successfully completed payment transaction which included the at least one product item of a purchase offer previously provided by the control system.

Certain examples provide a tangible computer-readable storage medium including computer program instructions which, when executed by a processor, are to implement a method. The example method includes initiating, based on a trigger, a subsequent purchase offer or discount query based at least in part on event data received by the control system. The example method includes searching for and retrieving subsequent purchase offer or discounts. The example method includes providing, using the processor without further user input, one or more identified subsequent purchase offers and/or discounts in the form of optically readable codes which determine validity of each subsequent purchase offers and/or discounts. The example method includes dynamically providing one or more subsequent purchase offers and/or discounts in response to received event data indicating a successfully completed payment transaction including a purchase offer previously provided by the control system.

In embodiments, the technology disclosed provide a control system including a processor configured to receive a trigger in the form of event data to initiate an optically readable code query in response to or based at least in part on the receiving of event data which was transmitted from a mobile device in response to the identifying of an event indicating the acceptance of a purchase offer by the user of the mobile device. The example control system may include at least one engine configured to dynamically create subsequent purchase offers and discount codes in response to receiving event data from mobile devices. The example control system may also include a validation engine configured to search and retrieve optically readable codes or data for generating and/or displaying optically readable codes on the screen of the mobile device. An example engine may be configured to provide one or more identified optically readable codes to a target mobile device to thereby determine the validity of each purchase offer. The example processor is to dynamically provide optically readable codes presented on a customer's mobile device in response to receiving event data representing the acceptance of a purchase offer. The optically readable code, when viewed, scanned or read, determines the validity of the previously provided purchase offer and may be used for validating or verifying to a communication device, computer unit, cashier system and/or staff member in a store that the user of a mobile device displaying the optically readable code is authorized to take advantage of the purchase offer.

Certain examples provide a method including initiating, by the control system and based on a trigger in the form of received event data, an optically readable code or data for generating and/or displaying an optically readable code on the screen of a mobile device. The example method includes searching for and retrieving optically readable codes using a processor. The example method includes providing, using the processor without further user input, an identified subsequent purchase offer or discount in the form of an optically readable code to a customer's mobile device, where the optically readable code, when scanned or read, determines the validity of the purchase offer. The example method includes dynamically providing one or more purchase offers or discounts to a customer's mobile device, or a group of customer's mobile device, in response to receiving, by the control system, event data representing the identification of an event indicating the acceptance of a purchase offer by the same customer.

Certain examples provide a tangible computer-readable storage medium including computer program instructions which, when executed by a processor, are to implement a method. The example method includes providing, based on a trigger, an optically readable code query based at least in part on event data received by the control system. The example method includes searching for and retrieving optically readable codes. The example method includes providing, using the processor without further user input, one or more identified optically readable codes which may be used to determine the validity of each purchase offer. The example method includes dynamically providing one or more optically readable codes to customer's mobile device in response to received event data indicating the acceptance, by the customer, of a purchase offer previously provided by the control system.

In embodiments, the technology disclosed relates to a system, methods and computer program products for capturing and acting in response to a sequence of events or subsequently received event data, e.g. automatically and in real-time, in order to provide a purchase offer comprising both a first physical product in the store which associated barcode was scanned or read by the mobile device receiving the purchase offer and a second product which associated barcode the mobile device was not scanned or read before receiving the purchase offer. After first receiving and then accepting the purchase offer, the customer typically needs to fetch at least one physical item of the second product and bring the at least one physical item of the first product and the at least one physical item of the second product to the cash register desk or and/or a self-checkout terminal. At the desk and/or terminal, the image data representing the purchase offer, e.g. an optically readable code which contents represents the purchase offer, is displayed on the screen of the mobile device and is then shown to a staff member at the cash register desk or is scanned or read by a device. The scanning or reading may performed by using a device communicatively connected to the cashier system of the store, thereby opening an exit gate, deactivating an alarm tag attached to a physical product item of the first or the second product of the purchase offer and/or validating or verifying that the user of the mobile device is authorized to take advantage of the purchase offer comprising at least one item of the first product and at least one item of the second product.

In embodiments, the provided purchase offer, including at least one item of the first product, which associated barcode was scanned before receiving the purchase, and at least one item of a second product different from the first product, where the combined purchase offer is at least partly based on previously received event data, i.e. received before the customer entered the store. The combined offer, including both the first product which physical product item's associated barcode label was scanned or read by the mobile device and the second product may then be created/constructed at least partly based on identified and/or received events and/or event data obtained before the customer entered the store, where the events and/or event data was identified by and/or received from at least one of the customer's own mobile device and the mobile devices of other customers. The previously identified and/or received events and/or event data may then be associated with previously performed purchases of items of the first product and of the second product, e.g. combined or aggregated purchases including at least one item of the first product and at least one item of the second product.

In aspects, the system, methods adapted for validly and computer program products of the technology disclosed are adapted for securely validating or verifying, to the staff member at the store and/or the cashier system of the store before payment, that a customer, or user of a mobile device, can take advantage of a purchase offer, e.g. a customized or personalized purchase offer, provided to the customer in response to identified events associated with the customer's mobile device and while the customer is present in the store.

In certain embodiments of the methods, systems and computer program products of the technology disclosed, the scanning or reading of the displayed optically readable code may automatically initiate a payment transaction for purchasing the at least one product item according to the price and conditions of the purchase offer provided to the customer's mobile device, e.g. by automatically providing, by the controls system, the payment credentials of the customer in response to the scanning or reading of the optically readable code.

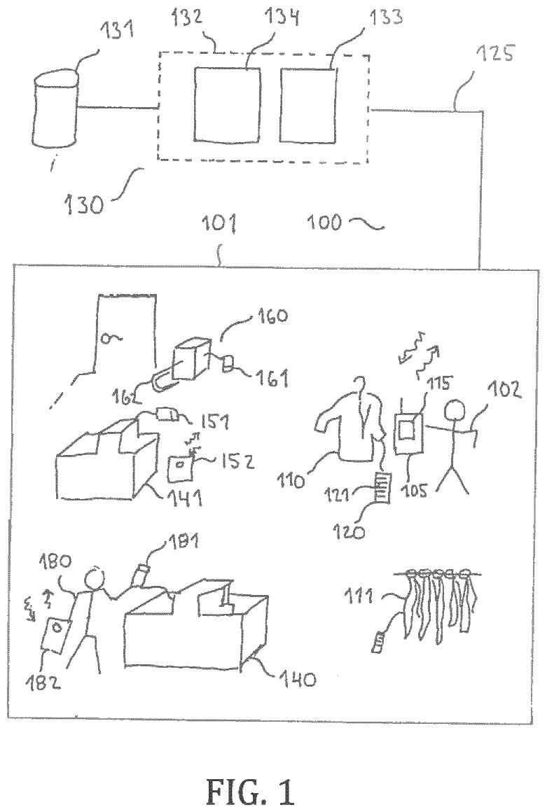

FIG. 1 illustrates a system 100 in which a mobile device 105 (e.g., a mobile telephone, personal digital assistant, smartphone, or other handheld device such as an iPhone or Android-based device) may be used to purchase a product 110 from a store 101, in accordance with some embodiments of the present disclosure. Mobile device 105 may be any mobile device having a processing capability, such as a cellular phone or a personal digital assistant (PDA). Mobile device 105 may be operatively connected to an image acquisition component 115, for example a camera integrated into the mobile device 105. Image acquisition component 115 may be any device component capable of capturing an image of information identifying a product Such information may include, for example, an image of a barcode (e.g., universal product code (UPC), a matrix barcode (QR code), three-dimensional barcode, or European Article Number (EAN)) on a label 120 affixed to product 110, an image of product 110 itself, an image of all or a portion of the packaging of product 110, or any other image that includes information identifying the product 110. In some embodiments, the image acquisition component 115 may further include optical character recognition capabilities, such that product names, brands, serial numbers, product numbers, or other text-based information may be read, digitally represented, and used in accordance with various implementations of the invention. In the examples below, label 120 is described as being a barcode. However, this provided merely as an example, as label 120 may be any product identifying number or may be any other information usable to identify product 110.

When a user of mobile device 105 intends to purchase a product 110 in the store 101, the user may use the image acquisition component 115 of the mobile device 105 to obtain an image that includes the product's barcode label 120 or other information identifying the product 110. The mobile device 105 may be programmed with an application program to communicate with a control system 130, or backend system, to capture events and transactions representing the user's interaction with the product 110 and, if desired, facilitate the purchase of products such as product 110. The application program may be installed on the mobile device in any of a number of ways. For example, the user may download the application program to the mobile device 105 from a developer of the application, from the control system 130, from the retail establishment, or from any other suitable source.

The control system 130, or backend system, may have access to any of various image recognition processes by which the barcode 121 of product 110 may be determined from the image taken of the barcode label 120. The control system 130 may also have access to product information for the product 110, including, for example, description and price information, through communication with a client database 131. Once control system 130 determines the barcode of the product 110, the control system 130 may transmit the corresponding product information to mobile device 105, in response to receiving from the mobile device the image taken of the barcode label 120.

The control system 130, or backend system, may then receive, from the mobile device 105, event data indicating the event of a successfully completed payment transaction including the purchase of the product items of a first purchase offer by the user of a mobile device and transmit, to the mobile device 105 and in response to receiving the event data indicating said event of a successfully completed payment transaction, an optically readable code, or data for generating an optically readable code, which is displayed on the screen/display of the mobile device 105.

The optically readable code displayed on the screen/display of the mobile device 105 in response to receiving the event data indicating the event of a successfully completed payment transaction may then be scanned or read by a scanner (151, 161) or image acquisition or recognition device (152, 182) at a self-checkout area or desk 141 or cash register desk 140 in the store 101, and may also be adapted to be used for deactivating an alarm tag attached to the first physical product item 110 corresponding to a product items of the first purchase offer. The successfully completed payment transaction may then be conducted by use of a digital wallet based mobile device 105, or the successfully completed payment transaction may have been conducted without any involvement by the mobile device 105. The event data transmitted following the identifying of at least one event indicating a successfully completed payment transaction may then be transmitted by the image acquisition or recognition device (152, 182) to the control system 130 and the control system may be configured to transmit, in response to receiving the event data from the image acquisition or recognition device (152, 182), the optically readable code, or data adapted for generating and/or displaying an optically readable code, to the mobile device 105. The image acquisition or recognition device (182) may then be operated by a staff member 180 in the store 101.

The optically readable code displayed on the screen/display of the mobile device 105 in response to receiving the event data indicating the event of a successfully completed payment transaction may then be scanned or read by a scanner or image acquisition or recognition device (151, 161) at a self-checkout desk 141 in the store 101 and/or at the exit gate area or desk 160 of the store 101, to thereby open an exit gate 162. The optically readable code, when scanned or read by a scanner or image acquisition or recognition device (151, 161) at the self-checkout area or desk 141 in the store 101 and/or at the exit gate area or desk 160 of the store 101, may then deactivate an alarm tag attached to the first physical product item 110 and/or automatically open the exit gate 162 in response to the scanning or reading of the optically readable code.

In embodiments, the technology disclosed relates to a system, methods and computer program products for capturing and acting in response to a sequence of events or subsequently received event data, e.g. automatically and in real-time, in order to provide a purchase offer comprising both a first physical product 110 in the store 101 which associated barcode label 120 was scanned or read by the mobile device 105 receiving the purchase offer and a second product 111 which associated barcode the mobile device was not scanned or read before receiving the purchase offer.

In example embodiments, the control system 130 may comprise a client database 131, or create/construct based on obtained event data, different purchase offers, e.g. personalized or customized purchase offers, which include at least one item of the first product 110 and at least one item of a second product 111, or the control system 130 may have access to purchase offers by retrieving information from, or through communication with, the client database 131. Once control system 130 determines the barcode 121 of the product 110, the control system 130 may transmit the corresponding product information to mobile device 105, in response to receiving from the mobile device the image taken of the barcode label 120.

After first receiving and then performing actions in the application program indicating the acceptance of the purchase offer by the customer 102, the customer 102 typically fetch at least one physical item of the second product 111 and bring the at least one physical item of the first product 110 and the at least one physical item of the second product 111 to a cash register desk 140 or and/or a self-checkout terminal 141. At the desk and/or terminal, the image data representing the purchase offer, e.g. an optically readable code which contents represents the purchase offer, is displayed on the screen of the mobile device 105 and is then shown to a staff member 180 at the cash register desk 140 or is scanned or read by a scanner 181 or an image acquisition device 182, e.g. a mobile communication device, operated by the staff member 180 at the desk 140 or a scanner 151 or an image acquisition device 152 operated by the customer at the self-checkout terminal 141. Thus, the scanning or reading may performed by using a device (151, 152, 181, 182) operatively coupled to or communicatively connected to the cashier system of the store 101, thereby validating or verifying that the user of the mobile device 105 is authorized to take advantage of the purchase offer comprising at least one item of the first product 110 and at least one item of the second product 111. The scanning or reading of the displayed optically readable code may automatically also initiate a payment transaction for purchasing the at least one product item according to the price and conditions of the purchase offer provided to the customer's mobile device.

In embodiments, the mobile device 105 and the control system 130 may communicate with each other (as well as other devices and data sources) via a network 125. The network communication may take place via any media such as standard and/or cellular telephone lines, LAN or WAN links, broadband connections (ISDN, Frame Relay, ATM), wireless links, and so on.

Preferably, the network 125 can carry TCP/IP protocol communications, and HTTP/HTTPS requests made by the mobile device and the connection between the mobile device 105 and the control system 130 can be communicated over such networks. In some implementations, the network includes various cellular data networks such as 2G, 3G, 4G, 5G and others. The type of network is not limited, however, and any suitable network may be used. Typical examples of networks that can serve as the communications network 125 include a wireless or wired Ethernet-based intranet, a local or wide-area network (LAN or WAN), and/or the global communications network known as the Internet, which may accommodate many different communications media and protocols.

The control system 130 may include various functional components, including, for example, a client database 131, a communications server 133 with Application Programming Interfaces (APIs) for interacting with the application program running on the mobile device 105, and an application server 134. In various implementations of the system according to the technology disclosed, the control system may also comprise a purchase server 132, which comprises the communications server 133 and the application server 134. In other implementations of the system according to the technology disclosed, at least the communication server 134 may be replaced by a microservices computer architecture with APIs for interacting with the application program running on the mobile device 105. The communication server 134, or the microservices computer architecture, provides the conduit through which requests for data and processing are received from the mobile device 105, as well as interaction with other servers that may provide additional product information such as product descriptions, inventory levels, pricing details. The communication server 134 may also transmit product and/or offer information to the mobile device 105 via the network 125. The application server 134 stores and executes the primary programming instructions for facilitating the functions executed on the purchase server 132. Data describing the product(s) and historical event data related to the user, the store, and/or the product may be stored in a client database 131 for use by the application server 134.

As the user shops, she can use the application program on the mobile device 105 to receive purchase offers and request information about product(s) she may considering purchasing. For example, she may scan the barcode symbol 121 on the barcode label 120 attached to the product 110 as well as receive pricing, warranty, delivery options, reliability or other information about the product that may influence her decision to purchase the product 110. She may use information about the product 110 to search other stores pricing, inventory or other sales parameters using a search application, either separate from the application program or embedded within the application program. She may confirm the purchase, or, in some cases, decide not to purchase the product and place the product back on the shelf.

The user may enter credit card information and authorization into a user interface of the mobile device 105, and the mobile device 105 may transmit the credit card information and authorization to the purchase server 132 of the control system to initiate a purchase of product 110. In some embodiments, purchase server 130 may also be in communication with an offer server (not shown), in which various offers from manufacturers and/or retailers may be stored in association with products (110, 111) offered for sale by the store 101.

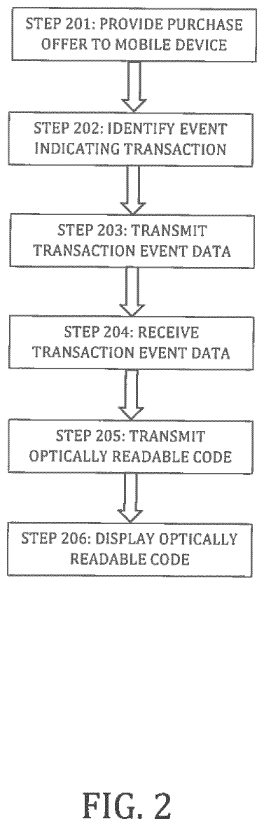

FIG. 2 is a flowchart illustrating a process according to certain embodiments of the technology disclosed, comprising the following steps:
a. provide purchase offer to mobile device (STEP 201);
b. identify, by mobile device, at least one event indicating a successfully completed payment transaction including the purchase of the product(s) of the of purchase offer (STEP 202);
c. transmit, by mobile device, event data representing the successfully completed payment transaction (STEP 203);
d. receive, by control system, event data representing the successfully completed payment transaction (STEP 204);
e. transmit, by control system, data for generating and/or displaying an optically readable code (STEP 205);
f. display, by mobile device, the optically readable code (STEP 206).

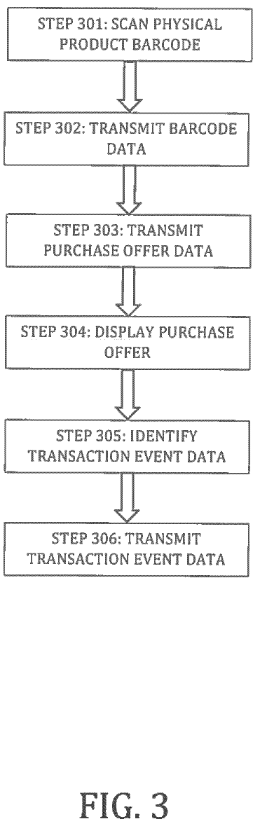

FIG. 3 is a flowchart illustrating a process according to certain embodiments of the technology disclosed, comprising the following steps:
a. scan a barcode associated with a physical product (STEP 301);
b. transmit data representing barcode (STEP 302);
c. transmit data representing the purchase offer (STEP 303);
d. display data representing the purchase offer (STEP 304);
e. identify at least one event indicating the event of a successfully completed payment transaction including the purchase of the product(s) of the purchase offer (STEP 305);
f. transmit event data representing the event indicating the successfully completed payment transaction (STEP 306).

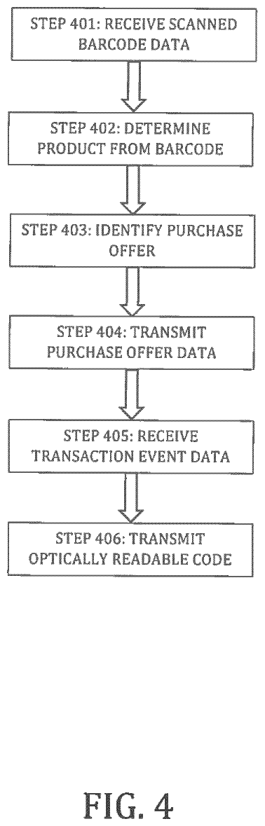

FIG. 4 is a flowchart illustrating a process according to certain embodiments of the technology disclosed where a control system is performing the following steps:
a. receive data representing scanned barcode (STEP 401);
b. determine product associated with barcode data (STEP 402);
c. identify purchase offer associated with identified product (STEP 403);
d. transmit data representing a purchase offer (STEP 404);
e. receive event data indicating a successfully completed payment transaction including the purchase of the product(s) of the purchase offer (STEP 405); and
f. transmit data for displaying an optically readable code (STEP 406).

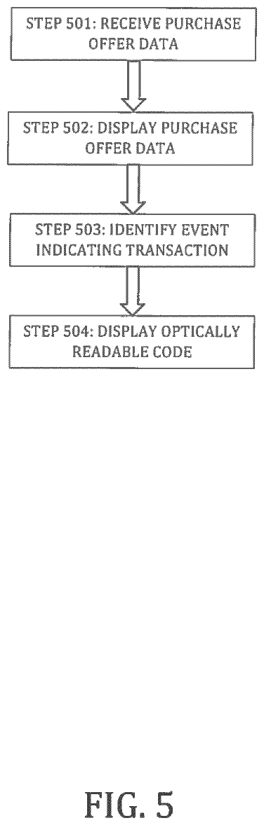

FIG. 5 is a flowchart illustrating a process according to certain embodiments of the technology disclosed where an application program is performing the following steps:
a. receive data representing a purchase offer (STEP 501);
b. display data representing the purchase offer (STEP 502);
c. identify the event indicating a successfully completed payment transaction including the purchase of the product(s) of the purchase offer (STEP 503); and
d. display an optically readable code (STEP 504).

A user interested in learning more about a product or considering purchasing the product uses initiates an application on her mobile device 105 which provides barcode and scanning functionality. The user scans the image, and the mobile app transmits the image data to the control system 130. The control system 130 processes the image received from mobile device 105 using an image recognition technique to identify the product associated with the transmitted image.

Once the product has been identified, the purchase offer associated with the product may be retrieved by a computer unit of the control system, for example, from a client database either stored on a purchase server or a separate data store and transmitted to the mobile device 105 where it is displayed to the user. The purchase offer may be displayed as an image, as a textual message, or a combination of the two.

In embodiments, the technology disclosed is directed to validating or verifying that a customer is authorized to take advantage of a purchase offer by providing a scannable and/or readable verification code, and more particularly to method and a system for capturing and acting on event data to provide secure verification of the customer's authorization to take advantage of the second purchase offer by providing the scannable and/or readable verification code in response to events identified by the application program running on the mobile device.

In embodiments and after receiving an optically readable code which contents at least partly represents the second purchase offer which available at the second store, the customer enters the second store and typically needs to fetch the at least one physical product item of the second purchase offer and bring the at least one physical item to the cash register desk or and/or a self-checkout terminal in the second store. At the desk and/or terminal, the image data representing the purchase offer, e.g. the optically readable code which contents represents the purchase offer, is displayed on the screen of the mobile device and is then shown to a staff member at the cash register desk of the second store or is scanned or read by a device. At the desk and/or terminal, the image data representing the second purchase offer, e.g. an optically readable code which content represents the second purchase offer, is displayed on the screen of the mobile device and may then be scanned or read by a device operated by a staff member of the second store at the cashier desk or a device operated by the customer at the self-checkout terminal, e.g. a scanner. Thus, the scanning or reading may be performed by using a device communicatively connected to the cashier system of the second store, thereby validating or verifying that the user of the mobile device is authorized to take advantage of the second purchase offer comprising the at least one physical product item brought to the cash register desk or and/or a self-checkout terminal.

In another aspect, a system for capturing event data resulting from a consumer's behavior at a store or retail establishment comprises a mobile device having at least one processor configured to obtain an image identifying a product via an image acquisition component, and transmit the image to a control system such as a purchase server. The processor is further configured to receive product information for the product, including price and description information, as well as receive instructions to search for additional product information related to the product, compare the product information and the additional product information, and update the product information based on the comparison. In different embodiments, the image acquisition component may be any device component capable of capturing an image of information identifying a product. Such information may include, for example, an image of a bar code (e.g., universal product code (UPC), a matrix barcode (QR code), three-dimensional barcode, or European Article Number (EAN)) on a label affixed to product, an image of product itself, an image of all or a portion of the packaging of product, or any other image that includes information identifying the product.

In another aspect, an article of manufacture having computer-readable program portions embodied thereon for capturing event data resulting from a consumer's use of a mobile device at the store comprises computer-readable instructions for obtaining, via an image acquisition component operatively connected to a mobile device, an image comprising information that identifies a product being offered for sale by a retail establishment. The article further comprises computer-readable instructions for transmitting the image from the mobile device to a control system, receiving at the mobile device, in response, product information comprising description and price information for the product, displaying the product information on a display of the mobile device, identifying an event in the application program running on the mobile device representing a decision by the consumer to purchase the product, and transmitting the event information from the mobile device to the control system. In different embodiments, the image acquisition component may be any device component capable of capturing an image of information identifying a product Such information may include, for example, an image of a barcode (e.g., universal product code (UPC), a matrix barcode (QR code), three-dimensional barcode, or European Article Number (EAN)) on a label affixed to product, an image of product itself, an image of all or a portion of the packaging of product, or any other image that includes information identifying the product.

In yet another aspect, an article of manufacture having computer-readable program portions embodied thereon for capturing event data resulting from a consumer's use of a mobile device at a retail establishment comprises computer-readable instructions for obtaining, via an image acquisition component operatively connected to a mobile device, an image comprising information that identifies a product being offered for sale by a retail store. The article further comprises computer-readable instructions for transmitting the image from the mobile device to a purchase server, receiving at the mobile device, in response, a purchase offer comprising description and price information for the product, receiving at the mobile device instructions to request for verification that the customer is authorized to take advantage of the purchase offer on a display of the mobile device, and requesting an optically readable code by selecting a button or menu option, e.g. pressing a button, link or area in the application program running on the mobile device or by activating input means of the mobile device.

In certain aspects, the technology disclosed relates to a system, method and mobile device for presenting a combined offer including a first product and a second product different from the first product, where a barcode associated with a physical product item of the first product was scanned by the user of a mobile device in the retail store and where the second product is added to the electronic basket of the mobile application program running on the mobile device without any need for the user to first scan a barcode associated with a physical product item of the second product According to embodiments, first event information is transmitted from the mobile device following the event of scanning the barcode associated with a physical product item of a first product and, in response to receiving the first event data/information from the mobile device, a backend system of the system transmits a purchase offer including the purchase of at least one item of the first product and at least one item of the second product.

Data or information defining and representing said offer for sale which preferably is only available for said mobile device, is transmitted, from said backend system to said mobile device which scanned the barcode associated with said first product or product category. The data or information defining and representing the offer for sale is transmitted, e.g. automatically transmitted, in response to the backend system receiving second event data from the mobile device, where the second event data is indicating at least one of the occurred event of adding said offer for sale or said second product or product category to the electronic shopping basket of a mobile application program running on said mobile device, the event of adding the second product or product category to the electronic shopping basket, and the event of activating a check-out functionality, e.g. by pressing a check-out button, in the mobile application program running on the mobile device. The check-out functionality may be used as indicator that the user of the mobile device wants to proceed to payment in accordance with the offer for sale and/or proceed to payment of at least one item of the first product or product category and at least one item of the second product or product category. In embodiments, the above-mentioned offer for sale was created/constructed by the backend system based on at least one of obtained first, second and third event data associated with the first and second product and which were previously received by the backend system from other mobile devices/customer and obtained first, second and third event data previously received from the mobile device. The third event data is then event data transmitted from a mobile device and received by the backend system following a confirmed payment transaction of a product or product category.

The user of the mobile device may then accept the first purchase offer by adding the products of the provided purchase offer or an item of a second product which was not scanned to the shopping basket and/or by checking-out the products of the provided purchase offer or an item of the second product for payment. In embodiments, selecting a purchase offer is equated to accepting one or more terms and conditions associated with the offer by adding the products of the provided offer or an item of the second product to the shopping basket and/or by checking-out the products of the provided purchase offer or an item of the second product for payment.

In embodiments, the acquisition of an image identifying a first product and in response to event data representing the event of acquiring the image and/or a subsequent event of adding an item of the first product to the shopping basket in the mobile application program running on the mobile device, the consumer is sent product information and/or a purchase offer from a backend system, where the purchase offers includes a second product different from the first product associated with the acquired image. The user of the mobile device may then accept the offer by adding the products of the provided offer or an item of the second product to the shopping basket and/or by checking-out the products of the provided purchase offer or an item of the second product for payment. In embodiments, selecting an offer is equated to accepting one or more terms and conditions associated with the offer by adding the products of the provided offer or an item of the second product to the shopping basket and/or by checking-out the products of the provided purchase offer or an item of the second product for payment.

Mobile device 105 and the control system 130 may be implemented in any suitable way. FIG. 1 illustrates an exemplary architecture for a mobile device 105 and a control system 130 that may be used in some embodiments. The mobile device 105 may include hardware central processing unit(s) (CPU), operatively connected to hardware/physical memory and input/output (UO) interface. Exemplary server of the control system similarly comprises hardware CPU(s), operatively connected to hardware/physical memory and input/output (UO) interface. Hardware/physical memory may include volatile and/or non-volatile memory. The memory may store one or more instructions to program the CPU to perform any of the functions described herein. The memory may also store one or more application programs.

Exemplary mobile device 105 and exemplary control system 130 may have one or more input and output devices. These devices can be used, among other things, to present a user interface and/or communicate (e.g., via a network) with other devices or computers. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Although examples provided herein may have described the servers as residing on separate computers, it should be appreciated that the functionality of these components can be implemented on a single computer, or on any larger number of computers in a distributed fashion.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only. The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Variations, modifications, and other implementations of what is described herein will occur to those of ordinary skill in the art without departing from the spirit and the scope of the invention as claimed.

1. A method for providing a user of a mobile device with an optically readable code following a payment transaction including a purchase offer provided to the customers present in a store, said method comprising:
a. acquiring or scanning, by an image acquisition component or a scanner operatively connected to the mobile device, an image or barcode associated with a physical product item being offered for sale by the store, wherein said physical product item belongs to a first product or first product category;
b. transmitting, by said mobile device, said image or barcode, or data representing said image or barcode, to a control system which is comprising, or is at least one of operatively coupled to and communicatively connected, to a database;
c. transmitting, from the control system to the mobile device, data representing a first purchase offer identified by said control system in response to receiving said image or barcode, or in response to receiving said data representing said image or barcode;
d. displaying, in a browser or an application program running on the mobile device and on the screen of said mobile device, data representing said first purchase offer, wherein said displaying of data representing said first purchase offer is performed in response to said mobile device receiving said data representing said first purchase offer;
e. conducting a payment transaction including the purchase of product items of said first purchase offer;
f. identifying the event of a successfully completed payment transaction including the purchase of the product items of said first purchase offer; and
g. displaying, in the application program running on the mobile device, an optically readable code, wherein said optically readable code is displayed following the identifying of the event of a successfully completed payment transaction.

2. The method of claim 1, wherein the content of said optically readable code is representing a second purchase offer different from said first purchase offer, and wherein said optically readable code is adapted to be used for validating or verifying, when scanned or read, that the user of the mobile device is authorized to take advantage of said second purchase offer.

3. The method of claim 1, wherein said optically readable code is representing a second purchase offer different from said first purchase offer, and wherein said optically readable code is adapted to be used for validating or verifying, to a staff member, a cashier system, and/or a computer system, unit and/or device in the store and when inspected by the staff member or scanned or read by a scanner or image acquisition or recognition device in the store, that a successfully completed payment transaction including the purchase of the product items of said first purchase offer has been validly completed.

4. The method of claim 1, wherein said payment transaction is conducted by the use of said mobile device, and wherein said event of a successfully completed payment transaction is identified by the application program running on said mobile device.

5. The method of claim 1, wherein said event of a successfully completed payment transaction is identified by the control system based on event data received from the cashier system of the store or other computer system, unit or device of the store, and wherein data for generating and/or displaying said optically readable code is transmitted from the control system to said mobile device in response to receiving said event data representing said identified event of a successfully completed payment transaction.

6. The method of claim 1, further comprising the steps of:
a. transmitting, from said mobile device to said control system, event data representing the identified event of said successfully completed payment transaction including the purchase of the product items of said first purchase offer; and
b. transmitting, from the control system to said mobile device, data adapted to be used for generating an optically readable code, wherein said transmission of said data is performed in response to and triggered by said control system receiving said event data representing the identified event of said successfully completed payment transaction including the purchase of the product items of said first purchase offer.

7. The method of claim 1, further comprising the steps of:
c. generating, by the application program running on said mobile device, an optically readable code corresponding to said data adapted to be used for generating an optically readable code; and
d. displaying, by the application program running on said mobile device and on the screen of said mobile device, said optically readable code.

8. The method of claim 1, further comprising the following steps prior to conducting the payment transaction:
a. identifying, by the application program running on the mobile device, the event of accepting, by the user of the mobile device, said first purchase offer; and
b. displaying, by the application program running on said mobile device, an optically readable code representing said first purchase offer or reflecting the items currently in the shopping basket including the product items of said first purchase offer, wherein said optically readable code representing said first purchase offer is a different optically readable code from the optically readable code displayed following said successfully completed payment transaction including the purchase of the product items of said first purchase offer.

9. The method of claim 1, wherein said optically readable code representing said first purchase offer or reflecting the items of the shopping basket, when scanned or read by a scanner or image acquisition device in the store, is adapted to validate or verify to staff members in the store or to the cashier system of the store that the user of the mobile device is authorized to take advantage of said first purchase offer.

10. The method of any of claim 1, further comprising the steps of:
a. generating, by the application program running on said mobile device, said optically readable code representing a second purchase offer different from said first purchase offer, wherein said optically readable code is generated in response to said identifying of the event of a successfully completed payment transaction; and
b. displaying, by the application program running on said mobile device and on the screen of said mobile device, said optically readable code representing said second purchase offer, wherein said optically readable code, when scanned or read by a scanner or image acquisition or recognition device in a second store different from said store, is adapted to validate or verify that the user of the mobile device is authorized to take advantage of said second purchase offer and may proceed to payment in accordance with the price and conditions of said second purchase offer.

11. The method of claim 1, wherein said optically readable code, when scanned by a scanner in a second store or shown to staff members in the second store, is adapted to be used for validating or verifying, at the second store, that the user of the mobile device is authorized to take advantage of a second purchase offer including at least one product available for sale at the second store.

12. The method according to claim 1, further comprising:
a. acquiring, by an image acquisition device operatively coupled to or communicatively connected to the cashier system of the store, said optically readable code representing said first purchase offer, thereby validating or verifying that the user of the mobile device is authorized to take advantage of said second purchase offer and may proceed to payment.

13. The method according to claim 1, further comprising:
a. scanning, by a scanner operatively coupled to the cashier system of the store, said optically readable code representing said first purchase offer, thereby validating or verifying that the user of the mobile device is authorized to take advantage of said second purchase offer and may proceed to payment.

14. The method according to claim 1, further comprising:
a. conducting said payment transaction by purchasing at least one item of said second product or second product category and/or in accordance with the price and/or conditions of said first purchase offer, wherein said payment transaction is conducted following said scanning of said optically readable code representing said first purchase offer is validating or verifying that the user of the mobile device is authorized to take advantage of said first purchase offer.

15. The method of claim 1, wherein said the optically readable code also includes payment credentials of the customer associated with the mobile device and said payment transaction is conducted automatically in response to scanning or acquiring an image of said optically readable code representing said first purchase offer by a scanner or an image acquisition device operatively coupled to or communicatively connected to the cashier system of the store.

16. The method according to claim 1, further comprising the following steps prior to transmitting said data representing said first purchase offer:
a. transmitting, from said control system to said mobile device, product and/or price information for said first product or first product category, wherein said product and/or price information for said first product is transmitted in response to receiving said barcode or data representing said barcode;
b. displaying said product and/or price information for said first product or first product category in the application;
c. identifying, by the application program running on the mobile device, an event associated with said first product or first product category, wherein said event comprises identifying at least one of the actions of adding at least one item of the first product or first product category to the shopping basket of the application program and checking out at least one item of the first product or first product category for payment; and
d. transmitting, from the mobile device and in response to identifying said event associated with said first product or first product category, event data representing said event associated with said first product or first product category, wherein said step of transmitting data representing said first purchase offer is performed in response to said control system receiving said event associated with said first product or first product category.

17. The method according to claim 1, wherein said step of identifying said event of accepting said purchase offer comprises identifying, by the application program, at least one of the events of:
a. adding, to the shopping basket of the application program running on the mobile device, at least one item of a second product or second product category different from said first product or first product category;
b. adding, to the shopping basket of the application program running on the mobile device, product items in accordance with said first purchase offer;
c. checking out, in the application program, at least one item of said second product or second product category for payment;
d. checking out, in the application program, product items in accordance with said first purchase offer;
e. pressing a button, link, area or object in the application program to thereby request verification of the authorized use of said first purchase offer; and
f. activating an input means of the mobile device to thereby request verification of the authorized use of said first purchase offer.

18. A control system for providing a user of a mobile device with a verification code following a payment transaction including a purchase offer provided to the customers present in a store, said control system is configured to:
a. receive event data indicating the event of a successfully completed payment transaction including the purchase of the product items of a first purchase offer by the user of a mobile device;
b. determine an optically readable code, or data for generating an optically readable code associated with said first purchase offer and/or the products of said first purchase offer;
c. transmit, to said mobile device and in response to receiving said event data indicating said event of a successfully completed payment transaction, an optically readable code, or data for generating an optically readable code, wherein said control system is further configured to:
d. receive an image or barcode, or data representing an image or a barcode, from a mobile device;
e. determine that said received image or barcode data is associated with a product item which belongs to a first product or first product category;
f. identify a first purchase offer associated with the first product or first product category; and
g. transmit data representing a first purchase offer to said mobile device, and wherein said control system is configured to perform the following steps prior to conducting the payment transaction:
h. receiving, from the same mobile device, event data indicating that the user of the mobile device has accepted said first purchase offer; and
i. transmitting, from the control system to the same mobile device, an optically readable code or data adapted to be used for generating an optically readable code representing said first purchase offer, wherein said optically readable code, when scanned or read, is adapted to validate or verify that the user of the mobile device is authorized to take advantage of said first purchase offer and proceed to payment in accordance with the price and conditions of said purchase offer, and wherein said transmission of said optically readable code, or data adapted to be used for generating an optically readable code, representing said first purchase offer is performed in response to and triggered by said control system receiving said event data indicating that the user of the mobile device has accepted said first purchase offer.

19. The control system of claim 18, wherein said control system is further configured to perform the following step prior to transmitting said data representing said first purchase offer:
a. transmitting, from said control system to said mobile device, product and/or price information for said first product or first product category, wherein said product and/or price information for said first product is transmitted in response to receiving said image or barcode or data representing said image or barcode.

20. An application program installed on a mobile device, said application program is configured to:
a. identify the event of a successfully completed payment transaction, or event data associated with a successfully completed payment transaction, including the purchase of the product items of a first purchase offer by the user of a mobile device; and
b. display an optically readable code in response to identifying said event or event data associated with the successfully completed payment transaction, wherein said application program is further configured to:
c. receive data representing a first purchase offer;
d. display image data representing said first purchase offer, wherein said step of displaying is performed in response to said mobile device receiving said image data representing said first purchase offer;
e. initiate a payment transaction including the purchase of product items of said first purchase offer;
f. identify the event of a successfully completed payment transaction including the purchase of the product items of said first purchase offer; and
g. display an optically readable code, wherein said optically readable code is displayed following the step of identifying the event of a successfully completed payment transaction including the purchase of the product items of said first purchase, wherein said application program is further configured to perform the following steps prior to conducting a payment transaction:
h. identify the event of accepting, by the user of the mobile device, said first purchase offer; and
i. display an optically readable code adapted for validating or verifying that the user of the mobile device is authorized to take advantage of said first purchase offer, and wherein said application program is configured to identify the event of accepting by identifying at least one of the events of:
j. adding, to the shopping basket of the application program running on the mobile device, at least one item of a second product or second product category different from said first product or first product category;
k. adding, to the shopping basket of the application program running on the mobile device, product items in accordance with said purchase offer;
l. checking out, in the application program, at least one item of said second product or second product category for payment;
m. checking out, in the application program, product items in accordance with said purchase offer;
n. pressing a button, link, area or object in the application program to thereby request verification of the authorized use of said purchase offer; and
activating an input means of the mobile device to thereby request verification of the authorized use of said purchase offer.
